(19) United States
(12) Patent Application Publication
(10) Pub. No.: US 2026/0289278 A1
(43) Pub. Date: Sep. 24, 2026

(54) SYSTEM

(71) Applicant: SoftBank Group Corp., Tokyo (JP)

(72) Inventor: Tsuyoshi SAWADA, Tokyo (JP)

(73) Assignee: SoftBank Group Corp., Tokyo (JP)

(21) Appl. No.: 19/568,920

(22) Filed: Mar. 17, 2026

(30) Foreign Application Priority Data
Mar. 19, 2025 (JP) 2025-045288

(51) Int. Cl. G06N 3/0475; G10L 25/63

(52) U.S. Cl. CPC G06N 3/0475; G10L 25/63

(57) ABSTRACT

A system includes a processor that is configured to provide, to a user, an interface for inputting a desired residential region in which the user wishes to live, analyze region information input via the interface and generate a prompt for instructing a generative AI model to propose candidate dwellings corresponding to the region information, and recognize an emotion of the user and adjust a content of a proposal based on the recognized emotion.

### CROSS-REFERENCE TO RELATED APPLICATION

This application is based on and claims priority under 35 USC 119 from Japanese Patent Application No. 2025-045288 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for supporting housing selection and related interior planning generally present static property information and limited recommendation functions that do not sufficiently reflect a user's real-time emotional state or nuanced preferences. Such systems typically rely on fixed rule-based filters and simple search criteria (for example, location, price, and floor area), and therefore fail to generate rich, context-aware proposals for candidate dwellings. Furthermore, known systems do not effectively utilize generative AI models to automatically compose and tailor proposals for dwellings, layouts, furniture, and electric appliances in an integrated manner. As a result, the user often needs to manually search and compare numerous options across multiple services, which increases cognitive load and time consumption. In addition, conventional systems provide limited support for post-selection processes such as contracting with vendors and arranging installation, thereby requiring the user to independently contact multiple service providers. Moreover, existing systems do not adequately integrate in-store navigation with digital recommendations, and thus do not smoothly connect online proposals with the physical locations of products in stores. Accordingly, there is a need for a system that can: (i) acquire desired regional information from a user, (ii) generate prompts for a generative AI model to propose highly relevant housing candidates, (iii) recognize a user's emotion and dynamically adjust proposal content, (iv) coordinate with vendors to execute contracts and installations for proposed dwellings, layouts, furniture, and electric appliances, and (v) guide the user to the physical locations of products in a store based on GPS-based position information.

### SUMMARY

In order to solve the above-described problems, according to one aspect of the present invention, there is provided a system comprising a processor, wherein the processor is configured to provide, to a user, an interface for inputting a desired residential region in which the user wishes to live. The processor is further configured to analyze region information input via the interface and generate a prompt for instructing a generative AI model to propose candidate dwellings corresponding to the region information, such that the generative AI model outputs housing proposals that are contextually relevant to the user's desired region. The processor is also configured to recognize an emotion of the user, for example based on user interaction patterns, biometric signals, or explicit feedback, and to adjust a content of the proposal, including the style, quantity, and type of presented options, based on the recognized emotion. In addition, in some embodiments, the processor is configured to coordinate with one or more external vendors to execute contracts and installations in order to provide to the user a proposed dwelling, a proposed layout, proposed furniture, and proposed electric appliances, thereby reducing the need for the user to independently manage multiple service providers. In further embodiments, the processor is configured to acquire location information of the user by using a GPS sensor and to provide a navigation function for guiding a location of a product inside a physical store based on the location information, so that the user can easily find and confirm, in the physical store, products corresponding to or related to the proposals generated by the generative AI model. Through these configurations, the system realizes an integrated environment in which region-based housing proposals, emotion-aware adjustment of proposals, vendor coordination for contracting and installation, and in-store navigation are all provided in a seamless manner.

The term “system” refers to an arrangement of one or more hardware and software components, including at least one processor and associated memory, input/output interfaces, sensors, and network interfaces, that cooperatively perform the functions described herein. The term “processor” refers to any hardware device or combination of devices, such as a central processing unit (CPU), graphics processing unit (GPU), microcontroller, dedicated logic circuitry, or a combination thereof, that executes instructions to perform the operations described in the claims.

The term “interface” refers to a hardware and/or software component, such as a graphical user interface, web page, application screen, or input form, that enables a user to input information or receive information from the system.

The term “desired residential region” refers to a geographic area, such as a city, district, neighborhood, or other definable locality, in which a user wishes to reside and that is input by the user through the interface.

The term “region information” refers to data representing the desired residential region, including, for example, place names, addresses, postal codes, map coordinates, or other location identifiers input by the user.

The term “prompt” refers to a piece of text, structured data, or a combination thereof that is generated by the processor and provided as input to a generative AI model to instruct the generative AI model to produce one or more outputs, such as proposals for candidate dwellings.

The term “generative AI model” refers to a machine learning model, such as a neural network, trained to generate content, including but not limited to text, images, or structured data, in response to a prompt, and configured to output candidate dwellings or other proposals based on the prompt.

The term “candidate dwellings” refers to one or more proposed housing options, such as apartments, houses, condominiums, or other residential units, that are suggested to the user as potential places of residence.

The term “emotion of the user” refers to an affective state of the user, such as satisfaction, frustration, interest, or confusion, detected or inferred by the system based on user interactions, biometric signals, explicit feedback, or other observable data.

The term “proposal” refers to one or more suggestions, recommendations, or options presented to the user, including proposed dwellings, layouts, furniture, or electric appliances, optionally customized based on user information or detected emotion.

The term “external vendors” refers to third-party entities, such as real estate agents, furniture suppliers, appliance manufacturers, installers, or service providers, that can enter into contracts with the user and perform delivery, installation, or other services related to the proposed items.

The term “contracts and installations” refers to processes by which binding agreements for the purchase or rental of a dwelling, furniture, or electric appliances are executed, and by which physical delivery, placement, or mounting of such items is carried out at a designated location.

The term “layout” refers to a floor plan or arrangement of rooms and spaces within a dwelling, including the configuration, size, and relative positions of rooms, doors, windows, and other architectural elements.

The term “furniture” refers to movable items intended to support various human activities in a dwelling, such as beds, chairs, tables, sofas, storage units, desks, and other interior furnishings.

The term “electric appliances” refers to electrical or electronic devices used in a dwelling, including but not limited to refrigerators, washing machines, televisions, air conditioners, lighting equipment, cooking appliances, and audio or video equipment.

The term “location information of the user” refers to data indicating a physical position of the user, such as geographic coordinates, indoor position estimates, or related positional data obtained by sensors.

The term “GPS sensor” refers to a hardware component or set of components capable of receiving signals from a Global Positioning System or equivalent satellite-based positioning system and determining a geographic location based on those signals.

The term “navigation function” refers to a function of the system that generates and provides guidance information, such as directions, routes, or maps, to assist the user in moving from a current position to a target position.

The term “physical store” refers to a real-world retail facility, showroom, or shop in which products, including furniture and electric appliances, are displayed or stocked and can be physically inspected or purchased by the user.

The term “location of a product inside a physical store” refers to a specific position or area within a physical store, such as an aisle, shelf, section, or display zone, at which a particular product is placed or available.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

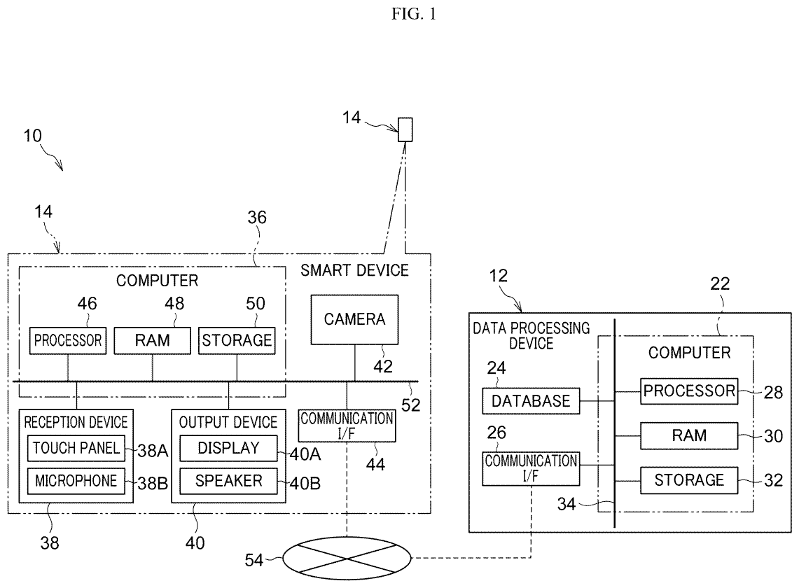

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

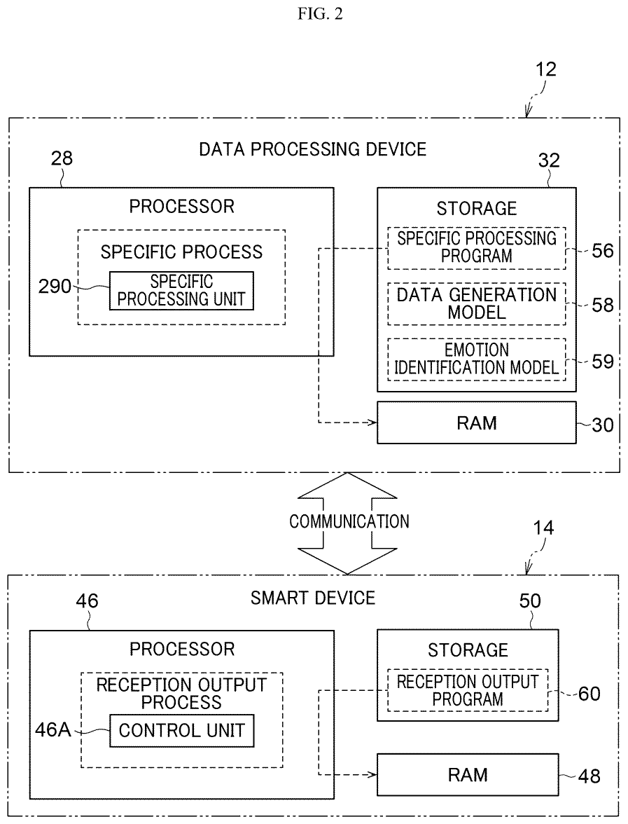

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for proposing residential environments typically rely on simple rule-based filtering and static templates. Such systems generally search a property database based on a user-specified region and then display a list of properties without deeply integrating floor plan information, furnishing information, and electric appliance information. As a result, the computation performed by the processor is fragmented across multiple, loosely coupled modules that do not share user history information or contextual information in a structured manner.

In addition, conventional systems often treat generative AI models, if used at all, as external black boxes that merely generate descriptive text. The processor usually does not construct a context-rich, structured prompt, nor does it systematically incorporate normalized region data, multi-level database results (real estate, spatial layouts, furnishings, appliances), and user history into such a prompt. Consequently, the generative AI output is often generic and not tightly aligned with the underlying database constraints, leading to inefficient computation, redundant data retrieval, and suboptimal use of computational resources. Further, traditional systems do not effectively utilize user input history and selection history as machine-readable user history information to adapt later computation steps. The processor frequently re-executes similar searches and ranking computations from scratch for each session, without leveraging accumulated preference patterns. This causes unnecessary database load, redundant processing, and lower responsiveness when generating personalized proposals.

Moreover, typical systems handle user emotion or preference only at the presentation layer, for example by changing display themes or simple ranking rules, without feeding such estimated emotional state or preference tendency back into the core computation pipeline. As a result, the processor cannot dynamically adjust how it constructs prompts for a generative AI model, or how it composes and filters candidate configurations before invoking such a model. This limits the ability of the system to improve recommendation quality and compute only the most relevant candidates for AI refinement.

Therefore, there is a need for a computer-implemented technique that improves the way a processor orchestrates database searches, user history management, and generative AI invocation. In particular, there is a need for a system in which the processor executes a coordinated sequence of data normalization, multi-layered search, prioritization, and prompt generation operations so that the generative AI model operates on a compact, highly relevant subset of data, and the resulting configuration plan can be efficiently refined based on user behavior and estimated emotional state. Such an approach can reduce redundant computation, improve data locality, and enhance overall system performance and personalization quality.

The specific processing by the specific processing unit 290 of the data processing device 12 in Example 1 is realized by the following means.

The present invention provides a server comprising a processor configured to provide, on an information processing apparatus, a user interface for receiving an input of a residential area desired by a user; to receive residential area information from a terminal and perform normalization and verification of the residential area information; to search, based on the normalized residential area information, a set of real estate information stored in a storage device and extract candidate real estate information; to acquire, from the storage device, a set of spatial layout information associated with the candidate real estate information and determine layout information including room types and floor areas; to search, based on the determined layout information, a set of furnishing information and select furnishing candidates suitable for dimensions and intended uses of respective rooms; to search, based on the selected furnishing candidates and the layout information, a set of electric appliance information and select electric appliance candidates suitable for conditions of the respective furnishings and the respective rooms; to store, in the storage device, user history information including an input history and a selection history of the user, and assign priorities to at least part of the real estate information, the layout information, the furnishing information, and the electric appliance information by using the user history information; to generate a prompt sentence for input to a generative information generation model based on the residential area information, the candidate real estate information, the layout information, the furnishing candidate information, the electric appliance candidate information, and the user history information; to cause the generative information generation model to operate on an external or internal information processing resource using the generated prompt sentence and thereby generate a residential environment configuration plan including a residence, a layout, furnishings, and electric appliances; to transmit the generated residential environment configuration plan to the terminal, cause the residential environment configuration plan to be presented via the user interface, receive a final selection result from the user, and update the user history information based on the final selection result; and to estimate an emotional state or preference tendency of the user based on at least one of user input content, user selection operations, and the user history information, and adjust at least one of the prompt sentence and contents of the residential environment configuration plan according to an estimation result. This enables the processor to execute an integrated, feedback-driven computation pipeline in which normalized region data, multi-layered database search results, user history information, and estimated user emotion are systematically fused into a structured prompt for the generative AI model, thereby reducing redundant database operations, improving relevance and efficiency of AI-based configuration generation, and enhancing the overall performance and personalization capability of the computer-implemented residential environment proposal system.

The term “processor” refers to a hardware computation element, such as a central processing unit or a processing core, configured to execute program instructions to perform data processing operations described in this specification.

The term “information processing apparatus” refers to an electronic device, including but not limited to a server, a client computer, or an embedded device, that executes software to provide a user interface and communicate with other devices over a communication network.

The term “terminal” refers to a user-operated electronic device, such as a mobile device, a tablet device, or a personal computer, that presents information to a user and transmits user input to a server over a communication network.

The term “user interface” refers to a software-implemented interaction mechanism, including graphical elements, input fields, buttons, and display regions, through which a user inputs information and receives output from the system.

The term “residential area information” refers to data representing a geographic region in which a user desires to reside, such as a city, district, or neighborhood, expressed in a textual or code-based form.

The term “normalization” refers to a process in which input data, including residential area information, is converted into a standardized internal representation, such as a canonical identifier or a normalized text string, to facilitate consistent searching and processing.

The term “verification” refers to a process in which input data is checked against reference data or rules, such as a stored list of valid regions, to confirm validity and detect errors or inconsistencies.

The term “storage device” refers to a hardware component, such as a magnetic disk, a solid-state drive, or a semiconductor memory, configured to store data including databases, user history information, and configuration information.

The term “real estate information” refers to structured data describing a property, including at least a location, a type of building, a layout type, a floor area, and other property-related attributes.

The term “candidate real estate information” refers to a subset of real estate information selected by applying search conditions, including at least a normalized residential area, to a stored real estate information set.

The term “spatial layout information” refers to data that defines an internal arrangement of spaces within a property, including room types, room dimensions, positional relationships, and boundary information.

The term “layout information” refers to processed spatial layout information that includes at least room types and floor areas used by the system for subsequent furnishing and appliance selection.

The term “furnishing information” refers to data describing interior articles used in a living environment, such as furniture items or decorative items, including at least item type, dimensions, style, and intended use.

The term “furnishing candidate” refers to furnishing information selected as a possible component of a residential environment configuration, based on compatibility with room dimensions, room usage, or user preferences.

The term “electric appliance information” refers to data describing electrically powered devices used in a living environment, including at least device type, capacity, dimensions, operational characteristics, and usage conditions.

The term “electric appliance candidate” refers to electric appliance information selected as a possible component of a residential environment configuration, based on compatibility with furnishings, room conditions, or user preferences.

The term “user history information” refers to data that records behavior of a user in the system, including at least inputs of residential areas, selections of properties, furnishings, and appliances, and final configuration decisions over time.

The term “input history” refers to a portion of user history information that records contents and timing of inputs provided by a user to the system, such as specified residential areas or filter conditions.

The term “selection history” refers to a portion of user history information that records choices made by a user, including selected properties, layouts, furnishings, and electric appliances during one or more sessions.

The term “priority assignment” refers to a process in which numerical scores or ranks are calculated for information items, such as real estate information or furnishing information, based on user history information or other criteria, to control ordering or filtering in subsequent processing.

The term “generative information generation model” refers to a machine learning model, such as a generative artificial intelligence model, configured to generate text or structured data in response to an input sequence, including at least a prompt sentence describing contextual information and requested output.

The term “prompt sentence” refers to text or structured data supplied as input to a generative information generation model, the text or data describing context, constraints, and instructions used by the model to generate an output.

The term “residential environment configuration plan” refers to data representing a proposed configuration of a living environment, including at least a residence, a layout of rooms, furnishings assigned to rooms, and electric appliances associated with the furnishings and rooms.

The term “external information processing resource” refers to a processing environment located outside a local system, such as a remote server or a cloud computing environment, on which a generative information generation model can be executed.

The term “internal information processing resource” refers to a processing environment located within a local system, such as an on-premise server or an integrated computing module, on which a generative information generation model can be executed.

The term “final selection result” refers to information indicating a conclusive choice made by a user from among proposed properties, layouts, furnishings, and electric appliances within a residential environment configuration plan.

The term “emotional state” refers to an inferred psychological condition of a user, such as satisfaction, dissatisfaction, or hesitation, estimated based on user input content, selection operations, and user history information.

The term “preference tendency” refers to an inferred pattern of user preferences, such as favored styles, price ranges, or spatial characteristics, derived from analysis of user history information and ongoing user behavior.

The term “external provider management information” refers to data describing providers of goods or services related to residences, furnishings, and electric appliances, including at least provider identifiers, supply conditions, and contact information.

The term “supply entity” refers to an entity that provides a property, furnishing, or electric appliance, or associated services, including but not limited to a seller, a lessor, or a service contractor.

The term “contract processing information” refers to data used to create, modify, or manage a contractual relationship between a user and a supply entity, including at least product identifiers, pricing conditions, and contractual terms.

The term “installation work information” refers to data describing operations required for installing furnishings or electric appliances, including at least scheduling information, location information, and work content.

The term “position detection apparatus” refers to a device or subsystem, such as a satellite-based positioning receiver or a local positioning sensor, configured to acquire location information of a terminal or a user.

The term “user position information” refers to data specifying a location of a user or a user's terminal, expressed, for example, as geographic coordinates or as a position relative to a reference point in a physical facility.

The term “physical facility” refers to a real-world structure, such as a store, a showroom, or a warehouse, in which physical products corresponding to furnishings or electric appliances are arranged.

The term “product arrangement information” refers to data that describes locations of products within a physical facility, including at least identifiers of display areas, coordinates, or paths to reach products.

The term “guidance route” refers to a path computed from a current position of a user or terminal to a product location within a physical facility, the path being represented as a sequence of waypoints or directional instructions.

The term “navigation information” refers to data presented to a user that indicates a guidance route, including at least directions, landmarks, or distance information for moving within a physical facility.

In one embodiment, a server provides a computer-implemented residential environment proposal system that operates in cooperation with a terminal and a user. The server includes at least one processor, a main memory, and a non-transitory storage device.

The storage device stores program instructions, multiple structured data stores, and parameters for a generative AI model. The terminal includes a processor, a display device, and an input device, and communicates with the server through a communication network such as the Internet.

The server uses general-purpose computing hardware, such as a processor based on an industry-standard instruction set, a volatile memory such as a dynamic random access memory, and a non-volatile storage device such as a solid-state drive. In one example, the server executes an operating system and a web application platform. The server may further include one or more accelerator devices, such as a graphics processing unit, used to execute neural network computations for a generative AI model.

The server stores, in the storage device, multiple databases implemented using a relational database management system or a key-value store. In one example, the server stores a real estate information table, a spatial layout information table, a furnishing information table, an electric appliance information table, and a user history information table. Each table uses a defined schema. For instance, the real estate information table includes, as fields, at least a property identifier, a normalized region identifier, a building type, a layout type, a floor area, and a rent or price value. The spatial layout information table includes, as fields, a layout identifier, a property identifier, a room identifier, a room type, a room floor area, and coordinate values for a room boundary. The furnishing information table includes, as fields, a furnishing identifier, a category code, dimensions, a style code, a price, and compatibility rules. The electric appliance information table includes, as fields, an appliance identifier, a device category code, dimensions, a capacity value, a power consumption value, and compatibility rules. The user history information table includes, as fields, a user identifier, an input history record, a selection history record, and derived preference features.

The terminal presents, under control of the server, a user interface for receiving a desired residential area from the user. The terminal displays text input fields, selection lists, or map-based selectors implemented by a graphical user interface framework. When the user enters a desired residential area, the terminal encodes the input into a structured message and transmits the message to the server via a communication protocol.

The server receives the message from the terminal and executes a normalization process for the residential area information. The server applies string normalization, such as case conversion, script unification, and removal of extraneous characters, and then maps the normalized string to a region identifier using a region dictionary table stored in the storage device. The server verifies that the mapped region identifier exists and is active. If verification succeeds, the server caches the normalized region identifier and associated metadata in memory. This normalization and verification process enables the server to use compact numeric identifiers in subsequent database queries, thereby reducing storage access cost and improving cache efficiency.

The server searches the real estate information table using the normalized region identifier as a primary condition. The server may further incorporate user history information, such as previously selected layout types and price ranges, to compute a priority score for each candidate property. The server uses an algorithm that combines static attributes and user history features into a ranking score. For example, the server may compute a weighted sum of normalized price, distance to a center point, and similarity of layout type to previous selections. The server then selects the top-ranked property records and stores them in memory as candidate real estate information.

The server retrieves spatial layout information associated with each candidate property by joining the real estate information table and the spatial layout information table on the property identifier. The server constructs layout information that includes room types and floor areas for each candidate property. The server also computes derived layout features, such as total living area, maximum room area, and aspect ratios for rooms, which are later used as features in furnishing and appliance selection logic.

The server accesses the furnishing information table and selects furnishing candidates for each room type and room size. The server compares room dimensions with furnishing dimensions using inequality constraints and discards furnishing items that do not fit within the room boundary. The server also applies compatibility rules stored in the furnishing information table, such as preferred combinations of furnishing categories and room types.

The server uses a scoring function in which a score is computed as a function of dimension fit, style code similarity to user preference features, and budget constraints inferred from user history. This scoring function is implemented as arithmetic operations on numeric features, enabling fast comparison of a large number of furnishing records.

The server similarly selects electric appliance candidates using the electric appliance information table. The server derives, from the layout information and furnishing candidates, physical constraints such as available wall width, typical viewing distance between a seating furnishing and a display device, and room volume. The server then filters appliance candidates based on these constraints. For example, the server may compute a recommended display size from the viewing distance and reject appliances whose dimensions diverge beyond a defined tolerance from the recommended size. The server also uses capacity values, such as cooling capacity for a climate control device, and matches them to estimated room volume using a rule-based function. This results in appliance candidate sets that already satisfy physical constraints before any generative AI processing occurs, reducing the search space and improving efficiency.

The server stores user history information progressively as the user interacts with the system through the terminal. For each session, the server records the residential areas input by the user, candidate properties viewed by the user, items selected by the user, and items rejected by the user. The server aggregates these records into derived preference features, such as a preferred range of floor area, a distribution of selected layout types, favored furnishing style codes, and typical budget intervals. The server encodes these features as numeric vectors stored in the user history information table, which can be directly used by arithmetic operations and machine learning algorithms. This conversion of history into structured, numeric preference vectors is not merely a business record but a technical data structure designed to optimize computational performance in subsequent steps.

The server uses the normalized residential area information, the candidate real estate information, the layout information, the furnishing candidate information, the electric appliance candidate information, and the user history information to generate a prompt sentence for a generative AI model. The server composes the prompt sentence in a deterministic manner using a template processor. The template processor selects and orders information fields such that the prompt remains within a predefined length limit while retaining high-importance features. The server ranks information fields by importance using a weighting scheme and truncates low-importance details when necessary. This structured prompt construction mechanism improves the effectiveness of the generative AI model because it delivers a dense, highly relevant context set, thereby reducing wasted computation on extraneous text.

In one example, the server constructs a prompt sentence such as:

“The user wants to live in Shibuya-ku, Tokyo. Based on this region, propose several suitable residential properties. For the chosen property, suggest a specific floor plan (including room names and sizes), suitable furniture for each major room, and matching home appliances for daily living. Consider space efficiency and a modern, neutral design style. Output your answer as a narrative followed by bullet points.”

In another example, the server constructs a more detailed, history-aware prompt sentence such as:

“The user previously selected modern-style furniture in neutral colors and prefers 3LDK apartments in central urban areas. The user has now selected a property in Shibuya-ku, Tokyo and confirmed Layout Plan A. The user has tentatively chosen a modern sofa set, dining table for four, and a 55-inch TV. Refine this configuration by confirming that the furniture and appliances fit the floor plan and by recommending any additional items (such as lighting or storage units) that match the user's style. Output a detailed explanation plus a short checklist of items.”

The server provides the prompt sentence to a generative AI model implemented as a neural network. In one embodiment, the generative AI model is a transformer-based neural network comprising multiple encoder-decoder layers. Each layer includes a multi-head self-attention mechanism, a feed-forward network with non-linear activation, and layer normalization. The server stores trained weights of the neural network in the storage device and loads them into a memory space accessible by an accelerator device. The server tokenizes the prompt sentence using a tokenizer consistent with the training of the model, maps tokens to numeric identifiers, and arranges the identifiers into an input tensor. The accelerator device performs matrix multiplication and non-linear activation operations on the input tensor, according to the trained weights, to generate an output token sequence representing the residential environment configuration plan.

The server controls the generative AI model using explicit parameters such as a maximum output length, a temperature value, a top-k or top-p sampling parameter, and a repetition penalty parameter. By adjusting these parameters, the server can control the diversity and determinism of the output. The server may select parameter sets based on user history, for example, using a lower temperature for users who consistently choose conservative configurations. This adaptive parameter control improves the match between model behavior and user expectations and reduces the likelihood of generating physically implausible configurations.

The server trains or fine-tunes the generative AI model using training data composed of past residential environment configurations, user feedback, and database records. The server defines a loss function that combines a cross-entropy term for next-token prediction with an auxiliary loss term that penalizes inconsistencies between generated configurations and database constraints. For instance, when the model output suggests a furnishing that does not match any record in the furnishing information table, the auxiliary loss increases. During training, the server performs gradient-based optimization, updating weights via backpropagation using an optimization algorithm such as stochastic gradient descent with momentum or an adaptive moment algorithm. The training process enforces consistency between generated text and the structured database, thereby reducing errors at inference time and decreasing the amount of post-processing correction needed.

The server analyzes the output from the generative AI model using validation logic. The server parses the generated text and extracts references to properties, layouts, furnishings, and appliances using pattern matching and token classification. The server then verifies that each referenced item corresponds to an existing record in the relevant database tables, and adjusts or replaces inconsistent items based on ranking scores. This tight integration between model output and structured data ensures that the final residential environment configuration plan remains feasible and improves overall system reliability.

The server estimates an emotional state or preference tendency of the user based on user behavior. The server uses a classifier model, which may be implemented as a smaller neural network or as a gradient boosting machine, that receives as input features such as click patterns, time intervals on particular screens, and changes in selection decisions. The classifier outputs an estimated emotional category and a confidence score. The server uses this estimation to adjust the prompt sentence and the selection of candidates. For instance, when the estimated emotional state indicates hesitation, the server may reduce the number of candidate options and focus on highly ranked items to avoid overwhelming the user. This behavior reduces the computational cost of subsequent searches and model invocations because the server processes fewer low-probability candidates.

The terminal presents the generated residential environment configuration plan in a structured manner. The terminal displays separate sections for property summary, layout overview, furnishing arrangement, and appliance assignment. The terminal also allows the user to modify or confirm each part. When the user makes a final selection, the terminal transmits the selection to the server, which updates the user history information table and recalculates preference features. By storing these final decisions as structured data, the server gradually refines the preference model and reduces the need for exhaustive searches in future sessions, thus improving processing speed and reducing communication traffic.

In another embodiment, the server uses the generated residential environment configuration plan to interact with external provider systems. The server maps selected items to provider identifiers using external provider management information, constructs standardized messages containing contract parameters and installation requirements, and transmits them over a secure communication channel. The server receives confirmation messages and stores them together with configuration identifiers in the storage device. This integration enables automated execution of downstream processes while still relying on the same underlying data structures and preference models that improved the upstream recommendation process.

In still another embodiment, the server uses position information acquired from a position detection apparatus associated with the terminal. The server matches the position to a physical facility map stored in the storage device and retrieves product arrangement information. The server computes a path from the current position to product locations corresponding to items in the residential environment configuration plan. The terminal displays navigation information, such as directional arrows and distance indicators, guiding the user through the physical facility. Because the server links the digital configuration plan with precise physical coordinates, the system provides a technically grounded navigation function beyond abstract recommendation.

The described embodiments improve computer technology in several ways. First, the use of normalized region identifiers and compact preference vectors reduces the size of query conditions and improves cache locality in the storage device, thereby increasing search speed. Second, the pre-filtering of candidates based on physical constraints before invoking the generative AI model reduces the size of the context and the number of tokens in the prompt sentence, lowering computation time for neural network inference. Third, the integration of auxiliary loss terms in training aligns the model output with database constraints, reducing the need for costly post-hoc corrections. Fourth, the adaptive control of model parameters based on user history and emotional state leads to more stable and predictable outputs, reducing error rates and repeated user interactions. Fifth, the structured prompt generation using ranked fields and deterministic templates enables consistent and optimized use of the generative AI model, which is distinct from generic text generation and provides a targeted computational improvement.

Because the server orchestrates these elements as a cohesive computation pipeline that exploits specific data structures, neural network architectures, and control algorithms, the system goes beyond a mere automation of manual selection. The system modifies how data is stored, searched, prioritized, and used as input to a generative AI model, thereby providing technical effects such as processing speed improvement, accuracy enhancement in configuration generation, reduction in storage access operations, and a decrease in unnecessary network traffic between the server and the terminal.

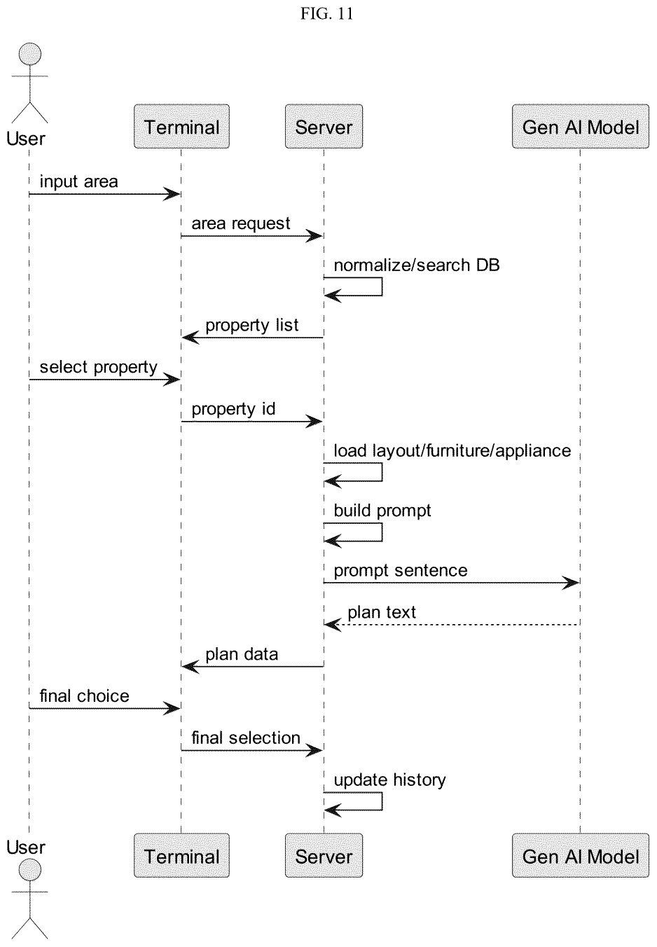

The following describes the processing flow using FIG. 11.

### Step 1:

User operates the terminal and inputs a desired residential area, such as “Shibuya-ku, Tokyo,” into a text field of the user interface.

Input: Natural-language text representing a desired residential area.

Terminal validates that the input is non-empty and in an acceptable character set, and then encapsulates the text into a request message.

Output: A structured request including the residential area text, transmitted from the terminal to the server over a communication network.

### Step 2:

Server receives the request and extracts the residential area text from the message.

Input: Request message containing the residential area text from the terminal.

Server applies text normalization operations, including converting characters to a canonical form, trimming whitespace, and standardizing region expressions. Server then looks up the normalized text in a region dictionary table stored in a storage device, using a database query.

Output: A normalized region identifier and associated region metadata, or an error indication if no match is found.

### Step 3:

Server verifies the normalized region identifier and prepares property search conditions.

Input: Normalized region identifier and region metadata.

Server checks that the identifier corresponds to an active region record and constructs a query condition vector that includes at least the region identifier and default constraints such as availability flags. Server may augment this vector with user preference features retrieved from user history information for the corresponding user identifier.

Output: A validated search condition set for real estate information, including region and optional preference-derived constraints.

### Step 4:

Server searches the real estate information table to obtain candidate properties for the specified region.

Input: Validated search condition set for real estate information.

Server executes a database query that filters records by region identifier and other conditions.

Server then computes, for each retrieved record, a ranking score by applying a scoring function that combines normalized price, floor area, and similarity to user preference vectors.

Output: An ordered list of candidate real estate records with associated ranking scores.

### Step 5:

Server retrieves spatial layout information corresponding to the candidate properties.

Input: Ordered list of candidate real estate records.

Server extracts property identifiers from the list and issues one or more queries to a spatial layout information table, joining on the property identifiers. Server constructs layout information objects that include room identifiers, room types, room floor areas, and coordinate values.

Output: A set of layout information objects associated with the candidate properties.

### Step 6:

Server derives layout features and prepares furnishing selection conditions.

Input: Set of layout information objects.

Server computes derived features such as total living area, maximum room area, and aspect ratios for each room by performing arithmetic operations on room dimensions. Server then associates each room type and room size with a furnishing category requirement and stores these as furnishing selection conditions.

Output: A structured set of furnishing selection conditions indexed by room, including room type, size, and derived layout features.

### Step 7:

Server searches the furnishing information table to select furnishing candidates for each room.

Input: Furnishing selection conditions.

Server executes database queries that filter furnishing records by category code and dimensions, rejecting records that violate room size constraints. Server calculates a furnishing score for each candidate by combining dimension fit, style similarity to user preference codes, and cost alignment with inferred budget ranges.

Output: For each room, a ranked list of furnishing candidates with computed scores.

### Step 8:

Server constructs appliance selection conditions using layout and furnishing candidates.

Input: Layout information objects and ranked furnishing candidate lists.

Server determines physical relationships, such as distance between a candidate seating furnishing and a potential display wall, and available wall widths. Server computes recommended capacity or size ranges for appliances, such as a recommended display size or cooling capacity, based on room area and furniture positions.

Output: A structured set of appliance selection conditions, including recommended size ranges, capacity ranges, and placement constraints for each room.

### Step 9:

Server searches the electric appliance information table to select appliance candidates.

Input: Appliance selection conditions.

Server filters appliance records by device category, dimensions, and capacity values, discarding records that fall outside recommended ranges computed in the previous step.

Server assigns an appliance score to each remaining record by combining fit with layout and furnishing constraints, energy efficiency attributes, and user preference features.

Output: For each room, a ranked list of appliance candidates that satisfy physical and preference-based constraints.

### Step 10:

Server updates and retrieves user history information to refine candidate ordering.

Input: Current candidate lists for real estate, furnishings, and appliances, and existing user history information.

Server aggregates recent interaction data, such as previously confirmed items and rejected items, into updated preference vectors using statistical operations (for example, updating running averages and frequency counts). Server then adjusts ranking scores of candidates by applying weight modifications derived from the updated vectors.

Output: Refined candidate lists for properties, furnishings, and appliances, reordered according to updated user preference estimations.

### Step 11:

Server constructs a structured prompt sentence for the generative AI model based on selected data.

Input: Normalized region information, refined candidate real estate information, layout information, furnishing candidate information, appliance candidate information, and user history information.

Server selects high-importance fields from each data set using predefined importance weights and arranges them according to a template, performing text concatenation and numeric-to-text conversions. Server also incorporates user preference summaries and, if available, an estimated emotional state label.

Output: A context-rich prompt sentence in natural language, formatted for input to a generative AI model.

### Step 12:

Server configures and invokes the generative AI model using the prompt sentence.

Input: Prompt sentence and model control parameters (such as maximum output length, temperature, and sampling strategy).

Server tokenizes the prompt sentence into token identifiers, forms an input tensor, and passes the tensor and control parameters to a transformer-based generative AI model running on a processor or an accelerator device. The model performs attention-based matrix multiplications and non-linear transformations layer by layer to generate an output token sequence.

Output: A generated token sequence that encodes a residential environment configuration plan text.

### Step 13:

Server decodes and validates the model output to obtain a consistent configuration plan.

Input: Generated token sequence from the generative AI model.

Server converts token identifiers back to text, segments the text into sections (property, layout, furnishings, appliances), and applies pattern recognition or rule-based parsing to identify references to items. Server verifies each referenced item against the real estate, furnishing, and appliance tables, and replaces or adjusts inconsistent references using nearest matching records based on similarity measures.

Output: A validated residential environment configuration plan that is consistent with stored database records.

### Step 14:

Server transmits the validated configuration plan to the terminal for presentation.

Input: Validated residential environment configuration plan.

Server encapsulates the plan in a response message and sends it to the terminal over the communication network. The message includes structured identifiers and human-readable descriptions for properties, layouts, furnishings, and appliances.

Output: A response containing the configuration plan, received by the terminal for display.

### Step 15:

Terminal presents the configuration plan and obtains final user selections.

Input: Response containing the configuration plan.

Terminal renders the configuration plan in separate UI sections, allowing the user to review details and modify individual choices. User interacts with selection controls, such as checkboxes or buttons, to confirm or change recommended items.

Output: A final selection message including identifiers of confirmed properties, layouts, furnishings, and appliances, transmitted from the terminal to the server.

### Step 16:

Server updates user history with final selections and adjusts future processing behavior.

Input: Final selection message from the terminal.

Server records the final selections in the user history information table, updating selection history records and recomputing preference vectors using the new data points. Server also logs the associated prompt sentence and generative AI output for analysis.

Output: An updated user history data set and associated preference vectors, which will serve as refined inputs for subsequent ranking, prompt construction, and generative AI invocations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems for residential environments suffer from several technical limitations. First, existing systems typically treat the selection of real estate, floor plans, furniture, and electric apparatus as independent and sequential tasks. As a result, the underlying information processing is fragmented across multiple subsystems, leading to redundant database access, inconsistent constraint enforcement, and increased latency in generating end-to-end proposals for a living environment. This fragmentation causes inefficient utilization of computing resources and degrades user-perceived responsiveness of the system.

Second, many known systems rely on static rule sets or simple filtering logic that are not capable of adaptively refining recommendation logic in response to complex user preferences and contextual constraints. Even when external machine learning components are used, such components are often invoked in an ad hoc manner without a structured, machine-readable representation of the intermediate recommendation state. This makes it difficult for the computing system to integrate machine-generated suggestions with existing structured data while maintaining consistency with hard constraints such as spatial dimensions, capacities, and budget limits.

Third, while generative AI models have emerged as powerful tools for generating natural language recommendations, conventional integrations typically pass only loosely structured text prompts and use the output purely as human-readable descriptions. The computer system cannot reliably parse and reuse such output as structured data for further computational processing. This results in a technical shortcoming: the recommendation pipeline remains largely manual at the integration points, and the computing architecture cannot fully leverage the generative AI model to optimize internal data structures, scoring functions, and selection logic. Consequently, the overall information processing system experiences unnecessary complexity, low throughput, and limited adaptability.

Accordingly, there is a need for an improved computer-implemented system and server-side processing architecture that: (i) unifies acquisition and normalization of residential region information; (ii) performs coordinated, constraint-aware searches across heterogeneous data repositories for real estate information, spatial layout information, furniture information, and electric apparatus information; (iii) generates and consumes prompt sentences that combine natural language and structured data in a machine-parseable form; and (iv) uses response information from a generative AI model not only for user-facing explanations but also to programmatically refine evaluation values and configuration plans. Such a system would improve the efficiency, scalability, and technical robustness of the recommendation pipeline executed by the server.

The specific processing by the specific processing unit 290 of the data processing device 12 in Application Example 1 is realized by the following means.

The present invention provides a server comprising a processor configured to provide, via an information input/output apparatus, a user interface through which a user inputs information indicating a desired residential region; to receive the residential region information transmitted from the information input/output apparatus, normalize the residential region information, and convert the normalized residential region information into geographic information; to search, based on the normalized residential region information, an information storage apparatus that stores real estate information, and acquire a set of candidate real estate information; to calculate, for the set of candidate real estate information, evaluation values using at least price information, area information, location information, building-age information, and user attribute information, and select a predetermined number of optimal real estate information items; to search, based on the selected optimal real estate information, an information storage apparatus that stores spatial layout information, evaluate spatial layout information with reference to user preference conditions, and select optimal spatial layout information; to search, based on room information and dimension information included in the optimal spatial layout information, an information storage apparatus that stores furniture information, extract furniture information that satisfies dimension conditions and user preference conditions, and generate a furniture configuration plan; to search, based on the furniture configuration plan including the furniture information and the room information, an information storage apparatus that stores electric apparatus information, extract electric apparatus information that satisfies dimension conditions, capacity conditions, and power-saving conditions, and generate an electric apparatus configuration plan; to generate a prompt sentence that integrates, at least in part, the optimal real estate information, the optimal spatial layout information, the furniture configuration plan, and the electric apparatus configuration plan as natural language information and structured data, transmit the prompt sentence to a generative AI model, and acquire response information including recommendation content or explanatory content from the generative AI model; to integrate the response information with the real estate information, the spatial layout information, the furniture information, and the electric apparatus information, generate proposal result information including recommended real estate, a recommended spatial layout, recommended furniture, and recommended electric apparatus, and transmit the proposal result information to the information input/output apparatus; and to receive selection information from the user regarding the proposal result information, and support a purchase process or a contract process for selected real estate, spatial layout, furniture, and electric apparatus. This enables a unified, computer-implemented recommendation pipeline in which the server efficiently orchestrates multi-stage database searches, structured evaluation and selection operations, and bi-directional integration with a generative AI model via machine-readable prompt sentences, thereby improving computational efficiency, data consistency, and responsiveness of the system compared to conventional architectures.

The term “system” refers to an arrangement of one or more computing devices, storage devices, and communication interfaces that cooperate to execute the processing described in the claims.

The term “processor” refers to one or more hardware processing units, such as a central processing unit, graphics processing unit, or other arithmetic and logic circuitry, configured to execute machine-readable instructions.

The term “information input/output apparatus” refers to an electronic device, such as a terminal, client device, or user equipment, that provides a user interface for receiving input from a user and presenting output to the user, and that communicates with the processor via a communication network.

The term “user interface” refers to a combination of hardware and software components, such as display screens, input fields, buttons, and touch controls, that enable a user to input information and receive information from the system.

The term “user” refers to a person or organization that operates the information input/output apparatus to request, view, or select proposals related to residential environments.

The term “desired residential region” refers to information indicating a geographic area in which the user wishes to reside, including, for example, names of cities, districts, neighborhoods, or equivalent geographic designations.

The term “residential region information” refers to data representing the desired residential region, including text strings, identifiers, or geographic coordinates provided or derived from user input.

The term “normalize” refers to processing residential region information to convert it into a standardized internal representation by operations such as format unification, character normalization, or mapping to standardized geographic identifiers.

The term “geographic information” refers to data representing one or more locations or areas on the earth, such as latitude and longitude, region codes, or other standardized geographic descriptors.

The term “information storage apparatus” refers to one or more storage systems, such as databases, file systems, or memory devices, that store structured or unstructured data used by the processor.

The term “real estate information” refers to data describing immovable properties, including attributes such as location, price, area, building age, type of structure, and availability.

The term “candidate real estate information” refers to one or more items of real estate information retrieved from the information storage apparatus as potential options for recommendation.

The term “evaluation value” refers to a score, ranking value, or metric computed by the processor for each candidate real estate information item, based on predetermined criteria and user-related data.

The term “price information” refers to data indicating a monetary value associated with a real estate property, furniture item, or electric apparatus, including purchase price, rent, or other cost parameters.

The term “area information” refers to data indicating a size or floor area of a property, room, or space, expressed in units of surface area or equivalent measures.

The term “location information” refers to data indicating a geographic position or address of a real estate property, including coordinates, region codes, or distance to reference points.

The term “building-age information” refers to data indicating the elapsed time since construction or a similar age-related attribute of a building.

The term “user attribute information” refers to data representing characteristics of the user, such as budget range, household size, lifestyle category, or other profile attributes stored by the system.

The term “optimal real estate information” refers to one or more items of real estate information selected by the processor from the candidate real estate information based on evaluation values and selection criteria.

The term “spatial layout information” refers to data describing the internal structure of a space, including room types, room dimensions, relative positions, and other layout characteristics.

The term “user preference conditions” refers to parameters indicating the user's desired features, such as number of rooms, presence of specific room types, interior style, or functional requirements.

The term “optimal spatial layout information” refers to one or more items of spatial layout information selected by the processor as most suitable for the optimal real estate information in view of the user preference conditions.

The term “room information” refers to data describing individual rooms or spaces within a property, including room type, location in the layout, and functional designation.

The term “dimension information” refers to data indicating size measurements, such as width, depth, height, or area, of rooms, spaces, furniture items, or electric apparatus.

The term “furniture information” refers to data describing articles used to equip an interior space, including type, dimensions, style attributes, price, and compatible room types.

The term “furniture configuration plan” refers to structured data indicating a set of selected furniture items and their association with specific rooms or spaces, optionally including placement information.

The term “electric apparatus information” refers to data describing electrical or electronic equipment used in a residence, including type, capacity, dimensions, energy-efficiency characteristics, and price.

The term “electric apparatus configuration plan” refers to structured data indicating a set of selected electric apparatus items and their association with specific furniture items or rooms, optionally including placement or connection information.

The term “capacity conditions” refers to constraints related to performance or size capacity of an electric apparatus, such as volume, load capacity, or output power, to ensure functional suitability.

The term “power-saving conditions” refers to constraints related to energy consumption or efficiency, such as efficiency ratings, maximum allowable power usage, or operation modes.

The term “prompt sentence” refers to data generated by the processor that combines natural language text and structured data summarizing at least part of the real estate information, spatial layout information, furniture configuration plan, and electric apparatus configuration plan, and that is provided as input to a generative AI model.

The term “generative AI model” refers to a machine-learned model configured to generate natural language text or structured data in response to a prompt sentence, based on parameters trained on large-scale data.

The term “response information” refers to data output from the generative AI model in response to the prompt sentence, including recommendation content, explanatory content, or proposed modifications to configuration plans.

The term “natural language information” refers to text expressed in a human language that can be read and understood by a human user, such as sentences describing recommendations or explanations.

The term “structured data” refers to data represented in a machine-readable format with defined fields or schema, such as key-value pairs, tables, or hierarchical data structures.

The term “proposal result information” refers to aggregated data generated by the processor that includes recommended real estate, recommended spatial layout, recommended furniture, and recommended electric apparatus for presentation to the user.

The term “selection information” refers to data indicating the user's selections or confirmations with respect to the proposal result information, including acceptance or rejection of specific items.

The term “purchase process” refers to a sequence of computer-implemented operations for completing a transaction to acquire rights or ownership of real estate, furniture, or electric apparatus, including payment processing and order registration.

The term “contract process” refers to a sequence of computer-implemented operations for generating, managing, or finalizing agreements related to real estate, spatial layout, furniture, or electric apparatus, including preparation of contractual documents and recording of consent.

The term “user position information” refers to data representing the physical location of the user or the information input/output apparatus, such as coordinates or location within a facility.

The term “facility position information” refers to data representing the physical layout or positions within a physical facility, including store layout, display locations, or route segments.

The term “guidance display” refers to visual or auditory output presented by the information input/output apparatus that indicates positions, directions, or additional information to guide the user within a physical or virtual space.

The term “route guidance” refers to information that indicates a path or sequence of positions within a physical facility, generated and presented by the system to direct the user to specific locations associated with proposal result information.

In one embodiment, a server executes a program that implements the claimed system using general-purpose computing hardware and standard software components. The server includes at least one processor, a main memory, a non-volatile storage device such as a solid-state drive, and a network interface coupled to a communication network. The server runs an operating system such as a general-purpose server operating system. The server executes application software implemented, for example, using Python with a web framework, or JavaScript with a server-side framework. The server accesses one or more database management systems such as a relational database and a document-oriented database to store and retrieve real estate information, spatial layout information, furniture information, and electric apparatus information. The server also communicates with a generative AI model hosted locally or remotely via a network API.

A terminal operates as an information input/output apparatus. The terminal includes a display device, an input device such as a touchscreen, keyboard, or pointing device, a local processor, and a wireless or wired communication interface. The terminal runs a web browser or a native application that executes client-side code implemented, for example, in HTML5, CSS, and JavaScript, or in a mobile development framework. The terminal presents a user interface to a user, transmits user inputs to the server via secure HTTP-based communication, and renders response data received from the server.

A user operates the terminal to input information indicating a desired residential region and to receive and review proposal result information. The user may further input profile information, preference information such as budget and style preferences, and selection information indicating which proposed items are to be accepted for purchase or contract.

The server stores real estate information in a first information storage apparatus, such as a relational database. The server stores each real estate item as a record having fields including, but not limited to, a property identifier, a geographic location code, a textual address, price data, floor area, building-age data, property type, and metadata such as proximity to transport facilities. The server indexes at least the geographic location code and price data fields to enable efficient search. The server stores spatial layout information in a second information storage apparatus that may be either in the same database or a separate database. The server represents each spatial layout item as a structured object that includes a layout identifier, a reference to at least one property identifier, and a list of room objects. Each room object includes a room type, dimensional parameters such as length, width, and height, and a position in a two-dimensional coordinate system representing the floor plan. The server stores furniture information and electric apparatus information in additional information storage apparatuses, as structured records including item identifiers, category codes, dimensions, style tags, capacity data, energy-efficiency data, and price data.

The server maintains user attribute information and user preference conditions in a user profile store. The server represents user attributes as key-value pairs including items such as household size, monthly budget, and preferred interior style. The server represents user preference conditions for spatial layouts as constraints such as a minimum number of rooms, required room types, and acceptable ranges for room areas.

The server performs normalization of residential region information by converting user-entered text into a standardized geographic representation. The server applies string normalization operations including trimming whitespace, converting character encodings, and mapping variant spellings. The server optionally sends a standardized address query to an external geocoding service via an API, receives latitude and longitude coordinates, and maps the coordinates to internal geographic region identifiers stored in a mapping table. By converting free-form user input into normalized geographic identifiers, the server reduces ambiguity and enables consistent search conditions across heterogeneous data sources, thereby improving search accuracy and reducing redundant queries.

The server executes search operations against the real estate information storage apparatus by constructing structured queries. If the real estate information is stored in a relational database, the server generates parameterized queries that constrain geographic fields, price ranges, and floor area ranges. The server sends the generated queries over an internal TCP-based connection to the database engine, which executes indexed lookups and returns result sets.

The server loads the result sets into memory as collections of real estate objects.

The server computes evaluation values for candidate real estate objects by executing an evaluation function. The server defines a feature vector for each real estate object that includes normalized price, normalized floor area, a transformed distance-to-facility value, a building-age score, and one or more user-specific preference scores. The server computes these feature values using numerical libraries that perform arithmetic and normalization operations. The server then calculates a scalar evaluation value as a weighted linear or non-linear combination of the feature vector components. The server may apply a learned weight vector obtained from an offline training process that minimizes an error function such as mean squared error between predicted scores and historical user preference data. By using a vector-based representation and numeric optimization for evaluation values, the server improves ranking precision over simple rule-based sorting and reduces human tuning effort.

The server selects optimal real estate objects by filtering out objects that violate hard constraints, such as exceeding maximum budget or lacking required room count, then sorting the remaining objects by their evaluation values. The server retains a predetermined number of top-ranked objects as optimal real estate information. This selection reduces the data volume for subsequent processing and focuses computational resources on promising options, improving overall throughput.

The server retrieves spatial layout information associated with the optimal real estate information by issuing queries keyed by property identifiers or by compatible floor area ranges. The server constructs spatial layout objects in memory, each including a list of room objects with types and coordinates. The server evaluates each spatial layout object using a layout suitability function that examines coverage of required room types, allocation of floor area among rooms, and geometric feasibility for furniture placement based on minimum clearance rules. The server computes a layout suitability score for each spatial layout object and selects one or more optimal spatial layout information items for each real estate item.

This approach allows the server to perform geometric reasoning that would be difficult to execute manually and ensures that the chosen layout supports downstream placement algorithms.

The server generates a furniture configuration plan by analyzing each optimal spatial layout information item. The server iterates through room objects, retrieves candidate furniture items from the furniture information storage, and evaluates whether each candidate fits into the room based on dimensional constraints and style constraints. The server models each room as a two-dimensional coordinate space and each furniture item as a rectangle with width and depth. The server executes a placement algorithm that tests candidate positions for collisions by checking overlapping rectangles and maintaining a spatial occupancy grid. The server employs heuristic or approximate algorithms to efficiently search placement configurations that maximize coverage of functional furniture without violating clearance constraints. The server thereby reduces the computation time required for layout search and ensures a collision-free arrangement.

The server generates an electric apparatus configuration plan by referencing both the furniture configuration plan and the spatial layout information. The server determines required apparatus categories for each room based on room type and presence of specific furniture items, such as assigning a display apparatus to a media cabinet. The server retrieves candidate electric apparatus items from the apparatus information storage, then applies constraint checks on capacities, dimensions, and energy-efficiency ratings. The server filters candidates that do not fit into allocated spaces next to or on top of specific furniture items by comparing apparatus dimensions to reserved zones in the room coordinate system. The server ranks remaining apparatus candidates by a combination of capacity satisfaction, power-saving characteristics, and cost. This approach reduces the likelihood of proposing apparatus that cannot be physically installed, thereby avoiding iterative manual adjustments by the user.

The server integrates the optimal real estate information, optimal spatial layout information, furniture configuration plan, and electric apparatus configuration plan into an internal representation suitable for both machine processing and natural language generation. The server constructs a structured data object that includes a hierarchy of properties, layouts, rooms, furniture sets, and apparatus sets. The server then generates a prompt sentence combining natural language phrases and embedded structured summaries. The server formulates the prompt sentence such that it is parseable by the generative AI model, while still conveying detailed context. An example of such a prompt sentence is:

“The user wants to live in ‘Shibuya-ku, Tokyo’ with a budget of 200,000 yen per month and prefers a minimalist interior style. We have selected three candidate properties with the following attributes: [summarized key attributes for each property in text form]. For the top property, propose an optimal floor plan configuration, a minimalist furniture set for each room, and suitable home appliances. Explain the reasoning and ensure all items fit in the given room dimensions.”

The server transmits the generated prompt sentence to a generative AI model through an API. In one embodiment, the generative AI model is a transformer-based neural network trained on large text corpora. The model architecture includes an embedding layer that maps tokens to high-dimensional vectors, multiple attention layers that compute contextual representations, and a final output layer that generates tokens for recommendations and explanations. The model parameters are trained offline using gradient descent algorithms that minimize a loss function such as cross-entropy loss between predicted tokens and ground-truth sequences. During training, the system may apply data augmentation techniques such as paraphrasing and random masking of words to improve robustness. The generative AI model thus learns patterns of household configuration and explanatory language.

The server receives response information from the generative AI model, including proposed modifications to the furniture configuration plan or electric apparatus configuration plan, and explanatory text describing the suitability of certain combinations. The server parses the response information using lexical and syntactic analysis to identify structured suggestion units such as “replace the sofa with a more compact model” or “add a desk in the second bedroom.” The server maps these suggestions to internal item identifiers by comparing described attributes in the text with the stored furniture and apparatus metadata. The server then validates each suggested change against hard constraints, including room dimensions and budget, and applies the change only if the constraints remain satisfied. By using the generative AI model output in this structured manner, the server enhances configuration diversity and explanation richness while maintaining constraint compliance, thereby improving the quality of recommendations compared to static rules.

The server generates proposal result information for transmission to the terminal. The server converts selected real estate information, spatial layout information, furniture configuration plans, and electric apparatus configuration plans into a compact structured representation.

The server performs data compression, such as omitting redundant attributes and encoding identifiers instead of full text, to decrease communication payload size and reduce network load. The server sends the structured proposal result information via a network protocol to the terminal, which then renders graphical views of floor plans, furniture arrangements, and apparatus placements.

The terminal presents to the user visual representations of the proposed layouts and configurations. The terminal can display a two-dimensional floor plan and overlay icons for each furniture and apparatus item at their assigned positions. The terminal can also provide interaction features such as highlighting items when the user selects them and displaying detailed specifications. This visualization helps the user understand the spatial relationships and supports decisions about which components to purchase or contract.

The server supports a purchase or contract process by interfacing with external transaction systems and payment processing services. The server generates order data structures containing identifiers for selected properties, spatial layouts, furniture items, and electric apparatus items, along with user identification data and payment details. The server performs transaction validation and communicates with payment gateways via secure APIs. The server stores order results in an order management database, which can be later referenced to coordinate logistics, such as delivery and installation.

The server improves computer technology in several respects. First, the server reduces end-to-end computation time and network load by unifying multiple recommendation stages within a single, constraint-aware pipeline. By performing normalized geographic mapping, vector-based evaluation, geometric collision detection, and prompt sentence generation on the server side, the system avoids repeated ad hoc queries and manual intervention, leading to more efficient use of processing and memory resources. Second, the server enhances recommendation precision through data structures and algorithms that enforce geometric and physical constraints before and after invoking the generative AI model. This reduces the need for human correction of infeasible layouts, thereby lowering error rates in recommended configurations. Third, the server utilizes a hybrid of explicit constraint checking and learned evaluation functions, which allows the server to adjust internal weighting factors based on historical behavior without rewriting rules, improving adaptability and accuracy.

The server further improves data management by structuring intermediate recommendation states as machine-readable objects, enabling traceability and incremental updates. This structure allows for incremental recomputation when user preferences change, instead of recomputing everything from scratch, thus improving computational efficiency. The prompt sentence mechanism, which integrates structured data summaries into natural language, improves communication between the deterministic pipeline and the generative AI model while maintaining parseability for the server. This reduces the risk of inconsistent or non-actionable AI outputs and prevents the generative AI component from functioning merely as a text generator for human consumption.

In another embodiment, the server operates with an alternative neural network architecture, such as a sequence-to-sequence model with attention, trained specifically on historical configuration data captured from the system. The server generates training examples where inputs include structured summaries of real estate and layout data, and outputs include configuration adjustments and explanatory phrases. The server applies an error function that penalizes both infeasibility of suggested configurations and divergence from user acceptance behavior. During training, the server updates model weights via backpropagation to reduce this error function. This design encourages the model to learn patterns that respect physical constraints and user preference distributions, yielding more technically applicable outputs at runtime.

In a further embodiment, the server uses a different strategy for integrating generative AI model outputs. The server constrains the output token space of the model by incorporating control tokens that reference internal identifiers or categories, which the server can directly map to database records. The server encodes these tokens in the prompt sentence so that the model learns to output control tokens rather than arbitrary words for critical decision points. This reduces ambiguity in mapping from natural language output to structured decisions, thereby improving robustness and consistency.

In yet another embodiment, the server coordinates the recommendation pipeline with a navigation function in a physical facility. The server receives user position information and facility position information from sensors or location services, then associates recommended items with physical locations such as showroom zones or display racks. The server transmits to the terminal instructions to display route guidance overlays and item highlights corresponding to the proposal result information. This integration provides a concrete technological application of the recommendation results, enabling the user to efficiently locate physical representations of recommended furniture and apparatus in real space, while the server optimizes path selection and updates routes based on dynamic facility conditions. Through these embodiments, the server, terminal, and user interactions collectively implement the claimed invention in a manner that is not limited to abstract data processing, but instead provides technical improvements to computer-based recommendation systems, including enhanced computational efficiency, improved constraint-compliant accuracy, optimized data flow, and effective integration of a generative AI model via structured prompt sentences and validated responses.

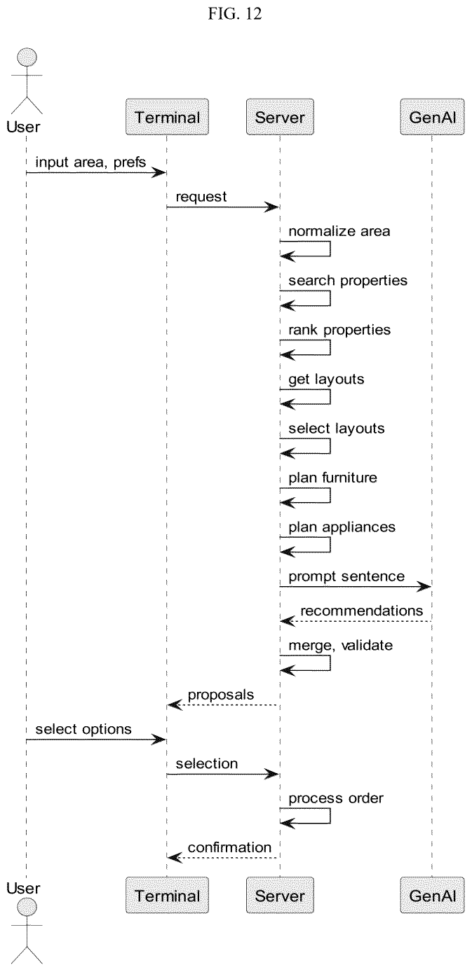

The following describes the processing flow using FIG. 12.

### Step 1:

The terminal displays, to the user, a user interface for inputting a desired residential region and preference conditions.

The terminal receives, as input, a text string representing the desired residential region (for example, “Shibuya-ku, Tokyo”) and optionally budget, preferred interior style, and required room types from input fields.

The terminal validates the input by checking that mandatory fields are not empty, that text lengths are within predetermined limits, and that numeric values such as budget are within predefined ranges.

The terminal generates, as output, a structured request object including the residential region string, user preference parameters, and a user identifier, and the terminal transmits this request object to the server via a secure network connection.

### Step 2:

The server receives, as input, the structured request object from the terminal through an application programming interface.

The server parses the request object to extract the residential region string and user preference parameters, and the server normalizes the region string by trimming whitespace, converting characters to a standard encoding, and mapping variant expressions to a canonical region name.

The server optionally sends the canonical region name as an input to a geocoding service and receives, as output, geographic coordinates and standardized location identifiers, which the server stores in association with the request.

The server generates, as output, a normalized residential region record containing canonical region identifiers and geographic coordinates, which becomes an internal key for subsequent database queries.

### Step 3:

The server receives, as input, the normalized residential region record and user preference parameters.

The server constructs one or more search queries for a real estate information storage apparatus by inserting the normalized region identifiers and applying constraints derived from the user's budget and required floor area.

The server executes these queries against the storage apparatus, which returns, as output, a set of real estate records that satisfy the geographic and basic constraint conditions.

The server accumulates these real estate records in memory as a candidate real estate set and prepares them for evaluation.

### Step 4:

The server receives, as input, the candidate real estate set and the user preference parameters.

The server computes, for each real estate record, a feature vector that includes normalized price, normalized floor area, transformed distance-to-transport, building-age score, and user-specific preference scores.

The server applies mathematical operations such as scaling, normalization, and weighted summation to these feature vectors to obtain, as output, an evaluation value for each real estate record.

The server filters out records whose evaluation values fail to meet minimum thresholds or whose attributes violate hard constraints, and the server sorts the remaining records by evaluation value to produce a ranked list of candidate real estate items.

### Step 5:

The server receives, as input, the ranked list of candidate real estate items.

The server selects a predetermined number of top-ranked items and extracts their identifiers as keys for spatial layout retrieval.

The server sends these identifiers as input to a spatial layout information storage apparatus and retrieves, as output, one or more spatial layout records associated with each selected real estate item.

The server aggregates these spatial layout records into layout candidates linked to respective real estate items.

### Step 6:

The server receives, as input, the spatial layout candidates and the user preference conditions related to room count, required room types, and functional requirements.

The server evaluates each spatial layout by counting room types, summing room areas, and checking whether the layout satisfies the required room configuration.

The server calculates a layout suitability score for each spatial layout by combining these checks with geometric feasibility metrics, such as the availability of contiguous space for key furniture categories.

The server selects, as output, one or more optimal spatial layout records for each real estate item, forming a set of real estate-layout pairs.

### Step 7:

The server receives, as input, the set of real estate-layout pairs, each including room information and dimension information.

The server iterates through rooms in each layout and generates, as input to a furniture information storage apparatus, a query that specifies room type, available floor area, and user style preference.

The storage apparatus returns, as output, a list of furniture items that match the specified categories and basic dimensional constraints.

The server refines this list by performing collision checks in a two-dimensional room coordinate system and eliminates furniture combinations that cannot be placed without overlap, thereby generating, as output, a furniture configuration plan for each layout.

### Step 8:

The server receives, as input, the furniture configuration plan and the associated spatial layout information.

The server determines, for each room, which categories of electric apparatus are required or recommended based on room type and furniture items present, such as assigning a display apparatus to a media cabinet in a living room.

The server queries an electric apparatus information storage apparatus with constraints on apparatus category, physical dimensions, capacity, and energy-efficiency rating.

The storage apparatus returns, as output, lists of candidate apparatus items, and the server filters and ranks these candidates based on satisfaction of capacity conditions, fit into reserved placement zones, and power-saving conditions, thereby generating, as output, an electric apparatus configuration plan.

### Step 9:

The server receives, as input, the optimal real estate information, the optimal spatial layout information, the furniture configuration plan, the electric apparatus configuration plan, and the user preference parameters.

The server constructs a structured internal representation that encodes these elements and then converts this representation, as input, into a prompt sentence that combines natural language descriptions with embedded summaries of key structured attributes.

The server sequences natural language segments and attribute summaries into a single text string that is syntactically consistent and machine-readable by a generative AI model.

The server generates, as output, a prompt sentence such as: “The user wants to live in ‘Shibuya-ku, Tokyo’ with a budget of 200,000 yen per month and prefers a minimalist interior style. We have selected three candidate properties with the following attributes: [summary]. For the top property, propose an optimal floor plan configuration, a minimalist furniture set for each room, and suitable home appliances. Explain the reasoning and ensure all items fit in the given room dimensions.”

### Step 10:

The server transmits, as input, the generated prompt sentence to a generative AI model via a network-based application programming interface.

The generative AI model processes the prompt sentence using a trained neural network and returns, as output, response information including suggested modifications to layouts, furniture sets, or apparatus sets, and explanatory text about the recommendations.

The server receives this response information and parses the text to extract structured suggestion units, such as indications of replacing specific item types or adding items to particular rooms.

The server maps these suggestion units to internal item identifiers and layout elements by matching described attributes against the stored metadata.

### Step 11:

The server receives, as input, the parsed suggestion units from the generative AI model and the existing configuration data for layouts, furniture, and apparatus.

The server validates each suggested modification by running constraint checks on dimensions, budget, and functional requirements to ensure that the proposed changes do not violate hard physical or financial constraints.

The server integrates accepted modifications into the furniture configuration plan and electric apparatus configuration plan, updating internal data structures to reflect new item selections or placements.

The server generates, as output, a refined set of configuration plans together with human-readable explanatory text associated with the changes.

### Step 12:

The server receives, as input, the refined configuration plans and associated explanatory text.

The server composes proposal result information that includes, for each candidate real estate item, its selected spatial layout, assigned furniture items with positions, assigned electric apparatus items with positions, and explanatory sentences describing the rationale.

The server serializes this proposal result information into a compact structured format and transmits it, as output, to the terminal over the network.

The server may also log a summary of the proposal and associated evaluation metrics for later analysis or model retraining.

### Step 13:

The terminal receives, as input, the proposal result information from the server.

The terminal parses the structured data and constructs display objects for real estate summaries, floor plans, furniture icons, and apparatus icons.

The terminal renders, as output, interactive views that show a list of recommended properties and, upon selection, detailed floor plans overlaid with furniture and apparatus positions.

The terminal highlights explanatory text when the user taps or clicks associated items, enabling the user to understand why specific items were recommended.

### Step 14:

The user reviews, as input, the displayed proposal result information on the terminal and performs selection operations such as accepting a particular property, layout, furniture set, and apparatus set.

The terminal collects the user's selection information, including identifiers of accepted items and any deselected items, and treats this collection as an input object for the server.

The terminal transmits the selection information, as output, to the server to request purchase processing or further refinement.

### Step 15:

The server receives, as input, the selection information from the terminal.

The server validates the selected items by checking availability, current pricing, and consistency with previously stored configuration constraints.

The server constructs order data structures that include references to the selected real estate, spatial layout, furniture, and electric apparatus, and sends, as input to external transaction systems, necessary payment and contract information.

The server receives, as output, transaction results from the external systems and generates confirmation data, which the server transmits to the terminal as final output for display to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented housing and interior proposal systems mainly function as static configuration tools that combine pre-registered floor plans, furniture catalogs, and rule-based filters. Such systems typically accept only limited, form-based inputs and generate proposals by matching user selections against predefined templates. As a result, these systems often fail to capture nuanced, natural-language requirements of individual users, such as lifestyle preferences, complex trade-offs between budget and spatial layout, and subtle interior style constraints. Moreover, conventional systems generally do not provide an integrated workflow that continuously connects proposal generation, user-driven refinement, and downstream coordination with external processing apparatuses for contracting, supply, and installation.

From a computer technology perspective, existing systems also exhibit several technical limitations. First, user requirements are often retained only as loosely structured records tied to fixed option codes, which constrains the way in which such requirements can be programmatically transformed into rich machine-consumable instructions. This limits the ability of back-end processors to leverage advanced generative AI models effectively, because the models are not provided with well-formed prompt sentences that include explicit roles, output formats, constraint conditions, and evaluation criteria. Second, conventional systems typically process generated proposals as opaque text or static images, without performing systematic parsing into structured proposal data that can be reused for multi-modal rendering, automated editing, and subsequent machine-to-machine interactions with external information processing apparatuses.

In addition, known systems generally lack mechanisms to continuously adapt proposal content and presentation based on the user's emotional state. User interfaces may be technically capable of displaying information, but they do not employ detected emotion information to dynamically adjust prompt sentences or proposal information in a way that improves system-level responsiveness, reduces repeated manual adjustments, or enhances the efficiency and effectiveness of human-computer interaction.

Furthermore, most systems do not provide an end-to-end technical pipeline that starts from structured acquisition of user requirement information, proceeds through automated construction and refinement of prompt sentences for a generative AI model, and culminates in machine-readable structured proposal data that directly drives external business processing such as contracting, supply, and installation, while also supporting navigation functions in physical spaces using positioning information.

Accordingly, there is a need for an improved computer-implemented system and server-side processing architecture that: (i) systematically transforms detailed, structured user requirement information into optimized prompt sentences for a generative AI model; (ii) programmatically converts the resulting proposal information into structured proposal data suitable for two-dimensional and three-dimensional rendering and automated editing; (iii) integrates user feedback and emotion information into iterative prompt updates; and (iv) coordinates downstream external processing, including navigation in physical spaces, in a manner that enhances the overall functioning of the computer system itself rather than merely substituting for mental processes or paper-based workflows.

The specific processing by the specific processing unit 290 of the data processing device 12 in Example 2 is realized by the following means.

The present invention provides a server comprising a processor and at least one memory storing instructions that, when executed by the processor, cause the processor to acquire, via an input/output apparatus, user requirement information including at least a residential area, a residential structure, a spatial layout, an interior style, installed articles, installed devices, and budget conditions, and to store the acquired user requirement information as itemized structured information in the memory; to convert, by executable string-processing operations, the structured information into a natural-language prompt sentence, to append control information that specifies at least a role, an output format, constraint conditions, and evaluation criteria of a generative information processing model, and to generate request information including the prompt sentence for input to the generative information processing model; to transmit the request information to the generative information processing model via a communication interface, and to receive proposal information generated by the generative information processing model on the basis of the prompt sentence, the proposal information including at least spatial layout information, installed article layout information, and installed device selection information; to analyze the proposal information to generate structured proposal data including at least attribute information, layout information, and required resource information for individual elements of a living space, and to generate, on the basis of the structured proposal data, display data for at least one of two-dimensional display and three-dimensional display, and to cause the input/output apparatus to present the proposal information and the display data to the user; to acquire, via the input/output apparatus, approval information or change request information from the user, and, when the change request information is acquired, to generate an updated prompt sentence that reflects the change request information, to generate updated request information including the updated prompt sentence, and to retransmit the updated request information to the generative information processing model so as to cause regenerated proposal information to be obtained; to, in response to the approval information, extract residential space information, installed article information, and installed device information from the structured proposal data, to communicate with at least one external information processing apparatus to exchange contract processing information, supply processing information, and installation processing information, thereby cooperatively executing business processing relating to acquisition of a living space, supply of installed articles, and installation of installed devices, and to aggregate progress states of the business processing and notify the aggregated progress states to the user via the input/output apparatus; and to acquire emotion information indicating an emotional state of the user and adjust at least one of content and expression format of at least one of the prompt sentence and the proposal information based on the emotion information. This enables a technical improvement in computer functionality by implementing an integrated, machine-executable pipeline that (i) transforms detailed structured user requirements into optimized prompt sentences for a generative AI model, (ii) converts AI-generated proposal information into structured proposal data suitable for multi-modal rendering and automated editing, (iii) dynamically adapts system outputs based on user emotion information, and (iv) programmatically drives downstream external processing and navigation tasks, thereby reducing manual configuration steps, improving the responsiveness and accuracy of proposal generation and refinement, and enhancing the efficiency and reliability of the overall computer-based housing and interior planning system.

The term “system” refers to a combination of at least one hardware apparatus and at least one software component that cooperatively execute information processing operations to implement the functions described in the claims.

The term “processor” refers to a hardware component, such as a central processing unit, a graphics processing unit, a digital signal processor, or a combination thereof, that executes machine-readable instructions to perform arithmetic, logical, control, and input/output operations.

The term “memory” refers to a hardware storage component, including at least one of a volatile storage medium and a non-volatile storage medium, that stores data and executable instructions for access by the processor.

The term “input/output apparatus” refers to a hardware and software combination that enables data to be input by a user and output to the user, and includes at least one of a display device, a touch panel, a keyboard, a pointing device, a speaker, a microphone, and associated interface software.

The term “user” refers to a human operator or an entity that interacts with the system by providing requirements, feedback, and approvals and by receiving proposals and status information.

The term “user requirement information” refers to data representing one or more conditions, preferences, or constraints specified by the user with respect to at least a living space, a spatial layout, articles to be installed, devices to be installed, and budget limitations.

The term “residential area” refers to information indicating a geographic region in which a living space is desired, including at least one of a country, a region, a city, a district, or a similar location specification.

The term “residential structure” refers to information indicating a type or configuration of a living space, including at least one of a detached building, a multi-unit building, a plurality of rooms, and associated structural attributes.

The term “spatial layout” refers to information describing the arrangement, size, adjacency, and functional allocation of spaces within a living environment, including at least rooms, corridors, and service areas.

The term “interior style” refers to information indicating aesthetic or design preferences for an interior environment, including at least model patterns, color schemes, material tendencies, and furnishing styles.

The term “installed articles” refers to tangible objects to be placed within a living space for human use, including at least furniture, fixtures, or similar movable or semi-fixed articles.

The term “installed devices” refers to tangible equipment that performs one or more electrical, electronic, or electromechanical functions within a living space, including at least household appliances and building service devices.

The term “budget conditions” refers to information specifying monetary constraints or ranges, including at least a maximum allowable cost or a target cost for acquiring, furnishing, and equipping a living space.

The term “itemized structured information” refers to data in which user requirement information is represented as a plurality of attributes and values organized into identifiable fields, records, or objects suitable for machine processing.

The term “string processing” refers to operations performed by the processor on character sequences, including at least concatenation, insertion, formatting, replacement, and template-based generation of textual data.

The term “natural-language prompt sentence” refers to textual data expressed in a human language, constructed to describe user requirements and control conditions in a form suitable for input to a generative information processing model.

The term “control information” refers to data that specify operational parameters for a generative information processing model, including at least a designated role, an output format, constraint conditions, and evaluation criteria.

The term “generative information processing model” refers to a machine learning model configured to generate output data, such as text, based on input data, including at least a large-scale neural network that produces a response to a given prompt sentence.

The term “request information” refers to data transmitted from the system to the generative information processing model, the data including at least one prompt sentence and associated control information.

The term “communication apparatus” refers to hardware and software components that enable data exchange over one or more communication networks, including at least network interfaces, communication protocols, and associated control logic.

The term “proposal information” refers to data generated by the generative information processing model in response to request information, the data including at least a proposed spatial layout, a proposed arrangement of installed articles, and a proposed selection of installed devices.

The term “spatial layout information” refers to a subset of proposal information that describes the arrangement and relationship of spaces within a living environment, including at least location, size, and connectivity of spatial elements.

The term “installed article layout information” refers to a subset of proposal information that specifies positions, orientations, and associations of installed articles within a living space.

The term “installed device selection information” refers to a subset of proposal information that specifies types, performance attributes, and, optionally, example models of installed devices to be used in a living space.

The term “structured proposal data” refers to data derived from proposal information in which elements of a living space, installed articles, and installed devices are represented as structured entities with associated attributes, layout parameters, and resource requirements.

The term “attribute information” refers to data describing characteristics of an element, including at least a type, a functional classification, a size, and other descriptive properties.

The term “layout information” refers to data specifying positional relationships among elements in a space, including at least coordinates, orientations, adjacency relations, and spatial constraints.

The term “required resource information” refers to data indicating resources needed to realize a proposal, including at least quantities, costs, installation requirements, and related logistical parameters.

The term “display data” refers to data prepared for rendering on a display device, including at least two-dimensional drawing data, three-dimensional scene data, or other visualization parameters.

The term “two-dimensional display” refers to a visual representation on a surface characterized by length and width, including at least plans, diagrams, or images without explicit depth interactions.

The term “three-dimensional display” refers to a visual representation that conveys depth information and allows at least one of rotation, scaling, or viewpoint change, including interactive or static three-dimensional scenes.

The term “approval information” refers to data indicating that a user has accepted at least a portion of the proposal information or structured proposal data as a basis for further processing.

The term “change request information” refers to data provided by a user indicating desired modifications to at least a portion of the proposal information, structured proposal data, or underlying requirements.

The term “updated prompt sentence” refers to a natural-language prompt sentence that incorporates change request information into an existing prompt sentence so as to cause modified proposal information to be generated.

The term “updated request information” refers to request information including the updated prompt sentence and, optionally, revised control information for the generative information processing model.

The term “residential space information” refers to data extracted from structured proposal data that describe the configuration, attributes, and layout of the living space as approved by the user.

The term “installed article information” refers to data extracted from structured proposal data that describe types, quantities, and placement of installed articles approved for use in the living space.

The term “installed device information” refers to data extracted from structured proposal data that describe types, specifications, quantities, and placement of installed devices approved for use in the living space.

The term “external information processing apparatus” refers to a system that is distinct from the system defined by the claims and that performs information processing related to at least contracting, supplying, or installing resources for the living space.

The term “contract processing information” refers to data exchanged with an external information processing apparatus to establish legal or commercial agreements related to a living space, articles, or devices.

The term “supply processing information” refers to data exchanged with an external information processing apparatus to arrange the procurement, shipment, or delivery of articles or devices.

The term “installation processing information” refers to data exchanged with an external information processing apparatus to arrange or confirm installation operations for articles or devices within a living space.

The term “business processing” refers to a sequence of machine-supported operations that implement at least contracting, supplying, and installing activities associated with realizing a proposed living space.

The term “progress state” refers to data indicating a stage or status within business processing, including at least initiation, in-progress, pending, completed, or failed stages for one or more tasks.

The term “emotion information” refers to data representing an estimated or detected emotional state of the user, including at least levels or categories such as satisfaction, dissatisfaction, interest, or hesitation.

The term “emotional state” refers to a condition of a user associated with feelings or attitudes at a given time, derived from at least explicit input, behavioral patterns, or sensor outputs.

The term “expression format” refers to the style, structure, or presentation parameters of textual or visual information, including at least tone, level of detail, ordering of information, and emphasis.

In one embodiment, the system includes a server, one or more terminals, and one or more external information processing apparatuses that are interconnected via at least one communication network. The server includes at least one processor, at least one memory, at least one storage apparatus, and at least one communication interface. The terminal includes at least one processor, at least one memory, a display device, and a user input device such as a touch panel or pointing device. The external information processing apparatus includes at least one processor, at least one memory, and a communication interface, and may be implemented as a contracting system, a supply management system, or an installation management system operated by a service provider.

The server executes a server-side application implemented, for example, by a web application framework such as a server-side scripting framework or an application server framework.

The server stores instructions and data structures in the memory and storage apparatus. The memory stores a data model for user requirement information, a data model for prompt sentences, a data model for proposal information, and a data model for structured proposal data. The storage apparatus may be implemented by a relational database management system, such as a database engine, or a document-oriented database system. The server also stores configuration parameters for a generative AI model, such as a transformer-based neural network model, in the memory.

The terminal executes a terminal-side application implemented, for example, in a web browser such as a standards-compliant browser using HTML, CSS, and JavaScript, or in a native mobile application using a mobile operating system framework. The terminal displays an input screen for user requirement information and sends the user requirement information to the server via an encrypted communication channel. The user operates the terminal to input values for at least a residential area, a residential structure, a spatial layout, an interior style, installed articles, installed devices, and budget conditions. The terminal may perform preliminary validation and formatting of the input data but does not execute the main generative processing; instead, the terminal transmits structured input fields to the server.

The server represents user requirement information as itemized structured information. The server uses a defined schema that includes, for example, a table or object representing a living space with fields such as “area_code,” “structure_type,” “room_count,” “layout_constraints,” “interior_style_code,” “furniture_preferences,” “appliance_preferences,” and “budget_range.” The server stores this itemized structured information in the memory and in persistent storage via a database interface. By normalizing user requirement information into itemized fields, the server enables deterministic and reproducible string-processing operations for generating prompt sentences.

The server generates a natural-language prompt sentence from the itemized structured information by executing string-processing operations. The server uses a template-based generator that concatenates pre-defined sentence fragments with field values from the structured information. For example, when the structured information contains the following values:
residential area: “a suburban district in a metropolitan region”
residential structure: “a detached house”
room configuration: “4LDK”
interior style: “a Scandinavian-style interior”
budget: “a budget of 70 million yen”
family structure: “a family of four with two small children” the server generates a prompt sentence such as:

“The user wants a 4LDK detached house in a suburban district of a metropolitan region, with a Scandinavian-style interior and a budget of 70 million yen for a family of four with two small children. Please propose a detailed floor plan, furniture layout, and recommended appliances.”

The server then appends control information to the prompt sentence. The server constructs, in memory, a message structure that includes at least one “system-level” instruction and one “user-level” instruction. For example, the server generates a system-level instruction such as: “You are a professional architect and interior designer. You propose realistic housing plans that conform to typical building standards and that are optimized for usability and energy efficiency.”

The server associates this system-level instruction with the prompt sentence to form request information. The server also sets numerical parameters such as a maximum number of output tokens, a sampling temperature, and a top-p parameter. These parameters are stored in the memory and are transmitted along with the text when the server communicates with the generative AI model.

The server interfaces with a generative AI model implemented as a transformer-based neural network. The generative AI model may be deployed on an external inference platform that executes a multi-layer encoder-decoder or decoder-only transformer architecture. The generative AI model receives tokenized text, computes contextual embeddings using self-attention mechanisms, and generates output tokens in an autoregressive manner. The model is trained, for example, by minimizing a cross-entropy loss function between predicted token distributions and ground-truth tokens using stochastic gradient descent or a variant such as Adam. During training, the model adjusts weight matrices in attention layers, feed-forward layers, and embedding layers. The server does not perform training in this embodiment but uses a pre-trained generative AI model that has been trained on large-scale text data including architectural descriptions, interior design descriptions, and device specifications.

The server transforms the prompt sentence and control information into token sequences by using a tokenizer library. The server sends the tokenized prompt and the parameters to the generative AI model via the communication interface using a defined application programming interface. The generative AI model returns output tokens that the server decodes into a text sequence. The server receives proposal information as this text sequence.

The server parses the proposal information into structured proposal data. The server applies rule-based parsers, regular expression patterns, and optionally a secondary constrained generative model to separate sections such as “Overview,” “Floor Plan,” “Furniture Layout,” and “Appliance List.” The server maps textual descriptions to structured records. For example, when the proposal information includes a sentence such as “The living room is approximately 20 square meters and is connected to an open kitchen,” the server extracts a room entity with an attribute “type=living room,” an attribute “area≈20 m²,” and a relationship “adjacent_to=kitchen, open_plan=true.” The server stores this structured proposal data in the memory using defined data structures such as room objects, furniture objects, and device objects, each with attributes and layout parameters.

The server generates display data from the structured proposal data. For two-dimensional display, the server computes a coordinate system for the living space and assigns approximate positions and sizes to each room and installed article based on the attributes and relationships in the structured proposal data. The server generates vector graphics or raster images that can be displayed by the terminal. For three-dimensional display, the server produces a scene graph that describes geometry, transformation matrices, and material properties of space elements and installed articles. The server stores the scene graph as a data structure that is interpretable by a three-dimensional rendering library, such as a WebGL-based engine, when received and processed by the terminal.

The terminal receives the display data from the server and renders it for the user. The terminal uses a graphics library to interpret geometry and layout metadata. The terminal displays a plan view as a two-dimensional layout and, when three-dimensional display is supported, reconstructs a three-dimensional model by instancing geometries for rooms, furniture, and appliances. The user observes the visualization and provides feedback through the input device. The terminal transmits the feedback to the server as change request information or approval information.

The server processes change request information by updating both the structured proposal data and the prompt sentence. The server compares the requested changes with existing structured proposal data and identifies the affected entities and attributes. For example, when the user requests “reduce the number of bedrooms from four to three and enlarge the kitchen,” the server modifies room objects corresponding to bedrooms and the kitchen. The server then generates an updated prompt sentence such as:

“Based on the previous proposal for a 4LDK detached house with a Scandinavian-style interior, please revise the plan to have 3 bedrooms instead of 4 and a larger kitchen area, while keeping the total budget close to 70 million yen. Maintain a family-friendly layout and a bright living-dining space.”

The server again sends request information including the updated prompt sentence and control information to the generative AI model. This iterative process allows the server to converge on a proposal that better matches user needs. Because the server uses structured proposal data to track and encode differences, the server can generate more accurate and contextually constrained prompt sentences, which reduces unnecessary model output variance and improves computational efficiency.

The server acquires emotion information that represents the emotional state of the user. The terminal may detect emotion information using, for example, a camera sensor and an audio input device, and may apply an emotion recognition model that classifies facial expressions, voice tone, or interaction patterns into categories such as satisfaction, confusion, or frustration. The server receives this emotion information and adjusts either the content or the expression format of the prompt sentence or the proposal information. For example, when the emotion information indicates confusion, the server modifies the prompt sentence to request more explicit step-by-step descriptions or simplified language, and modifies the display data to highlight key differences between successive proposals. This adjustment changes the behavior of the overall system in a way that cannot be achieved by static templates, and improves the clarity and usability of the output.

The server communicates with external information processing apparatuses using structured proposal data. When the user approves a proposal, the server extracts residential space information, installed article information, and installed device information. The server then sends this information to external apparatuses through machine-to-machine communication interfaces. The server, for example, transmits a list of furniture items with dimensions and placement constraints to a supply management apparatus, which uses this structured data to optimize packing and delivery schedules. The server also transmits installation requirements for devices to an installation management apparatus, which may compute installation routes and schedules. In some embodiments, a positioning apparatus, such as a satellite-based positioning unit or an indoor localization unit, provides position information. The server associates the structured proposal data with physical locations of actual articles in a physical space, and the terminal displays navigation guidance to direct the user from the current position to the location of a corresponding article or device.

The system improves computer technology by defining and enforcing a specific data flow and data structures between the user requirement layer, the generative AI layer, the structured proposal layer, and the external apparatus layer. The server reduces computational overhead by using structured itemized data to generate concise and well-formed prompt sentences, thereby reducing unnecessary verbosity and improving convergence of the generative AI model. The server also improves accuracy by mapping generative outputs to structured entities and validating them according to spatial constraints and resource constraints. For example, the server can detect inconsistencies such as overlapping furniture placements or exceeding budget conditions and can correct or re-request proposals with refined constraints.

The generative AI model in the system does not merely replace human authorship; rather, the server uses the model within an engineered pipeline that includes pre-processing, structured parsing, constraint checking, and post-processing. The model is a multi-layer transformer network with attention heads that capture relationships between spatial terms, dimension terms, and functional terms in the prompt sentence. The server uses this property by encoding prompts in a way that exposes key constraints in a consistent token pattern, which leads to improved proposal quality and reduced need for manual editing. The server can additionally apply a finetuning procedure, prior to deployment, in which a subset of model parameters is updated using training data containing pairs of requirement descriptions and high-quality structured proposals, with an objective function that penalizes spatial inconsistencies or budget violations. This additional training leads to a model behavior that is optimized for the specific technical domain of living space planning.

In an alternative embodiment, the server deploys a separate discriminator or critic module that evaluates generated proposal information before accepting it. The server uses a scoring function that considers, for example, total area coherence, ratio of circulation space to living space, and energy efficiency of selected devices. The server can reject or revise proposals that do not meet threshold scores. This architecture improves the reliability of the system and reduces the number of iterations required to obtain an acceptable proposal, thereby improving processing speed and reducing communication load between the server and the generative AI model.

The server also implements caching and reuse of intermediate structured proposal data. When numerous users submit similar user requirement information, the server retrieves existing structured proposal data and either reuses it directly or provides it as context to the generative AI model. This caching reduces redundant computation by the generative AI model and decreases network utilization. The server maintains an index over structured proposal data keyed by attributes such as residential area type, room count, and interior style. By searching this index prior to invoking the generative AI model, the server achieves a technical effect of reducing average response latency.

The system is not limited to a single generative AI model. In another embodiment, the server uses a first generative AI model to generate a coarse proposal and a second, smaller generative AI model to perform refinement and normalization of text into a canonical format that is more suitable for parsing. The server thus divides computation across models and uses smaller models where possible to reduce computational cost. The server manages these models by a scheduler that takes into account current load, expected response sizes, and quality-of-service constraints.

The system can be implemented in various deployment configurations. In a cloud-based implementation, the server resides in a data center and serves terminals over a wide-area network. In an on-premises implementation, the server may be installed in a local network and communicate with a locally hosted instance of the generative AI model. In a hybrid implementation, the server may run core processing locally while offloading generative computations to an external inference service. In each case, the server maintains the data structures and processing flows described above.

Because the server uses structured data representations, deterministic prompt generation, constraint-aware parsing, and emotion-based adaptation in a combined architecture, the system achieves technical effects such as improved processing speed, reduced errors in spatial and resource planning, reduced communication overhead, and improved robustness of human-computer interaction. The system therefore goes beyond mere automation of mental steps or business practices and instead implements a specific improvement to computer-based generation, management, and utilization of complex, multi-attribute proposal data.

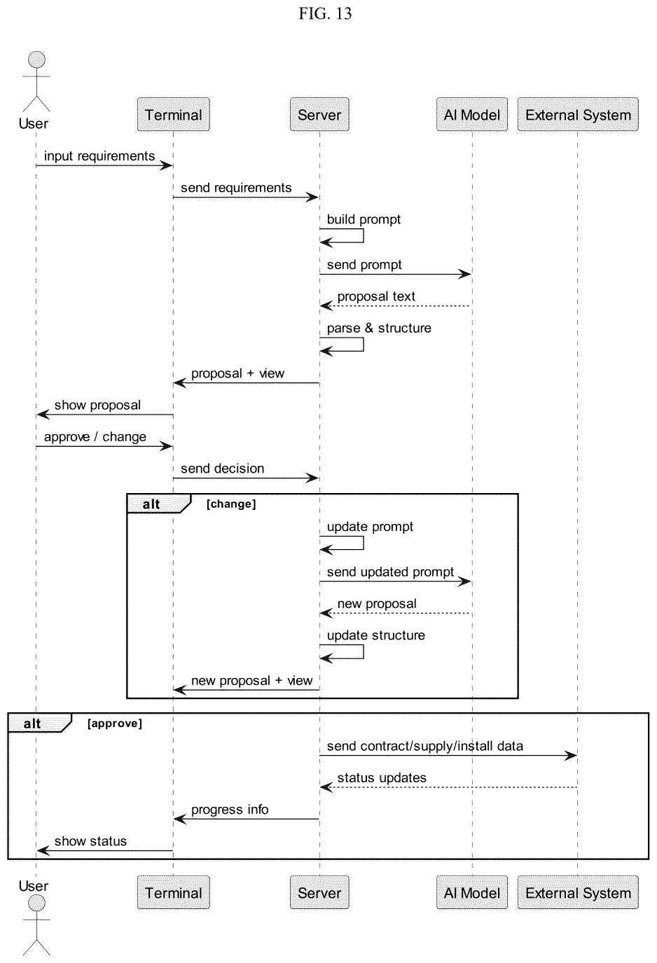

The following describes the processing flow using FIG. 13.

### Step 1:

The terminal displays an input screen for user requirement information.

The terminal receives, as input, user operations on a display and input device, including typed text, selection of options, and activation of buttons.

The terminal presents input fields for at least a residential area, a residential structure, a spatial layout, an interior style, installed articles, installed devices, and budget conditions.

The terminal validates the entered values locally, for example by checking that numeric values such as budget are within allowable ranges and that mandatory fields are not empty.

The terminal outputs a structured set of user requirement data, for example as a key-value collection in memory, and prepares this data for transmission to the server.

### Step 2:

The terminal transmits the structured user requirement data to the server.

The terminal uses a communication library to serialize the structured data into a message format and to send the message via a secure communication protocol.

The terminal sets message headers including a user identifier, a session identifier, and a timestamp.

The terminal outputs a network request containing the structured requirement data, and the server receives this network request as input.

### Step 3:

The server receives the structured user requirement data from the terminal.

The server parses the received message using a message parser and recovers the itemized fields, such as the residential area code, structure type, room count, interior style code, and budget range.

The server performs backend validation by checking data types, verifying that codes correspond to known entries, and rejecting malformed or inconsistent combinations.

The server stores the validated itemized structured information into a persistent storage apparatus by executing insert operations against a database engine.

The server outputs normalized requirement records referenced by an internal requirement identifier.

### Step 4:

The server generates a natural-language prompt sentence based on the itemized structured information.

The server takes, as input, the normalized requirement records for a particular user or session.

The server executes string-processing operations that retrieve template fragments from a template store and fill placeholders with specific field values, such as area descriptions, room configurations, and style names.

The server concatenates these fragments to form a continuous natural-language description of the user's requirements.

The server appends control information specifying a role, desired output structure, constraints, and evaluation criteria for a generative AI model.

The server outputs a prompt sentence and associated control parameters ready to be sent as request information to the generative AI model.

### Step 5:

The server prepares request information for the generative AI model.

The server receives, as input, the prompt sentence and the control parameters generated in Step 4.

The server uses a tokenizer to convert the textual prompt into tokens and assembles a request object that includes the tokenized prompt, control parameters such as maximum output length, temperature, and top-p, and model identification data.

The server outputs a structured request packet formatted in accordance with an application programming interface of the generative AI model.

### Step 6:

The server transmits the request information to the generative AI model and receives proposal information.

The server sends, as input to the generative AI model, the request packet via a communication interface over a network channel.

The generative AI model executes neural network computations, including embedding lookups, attention-based transformations, and feed-forward computations, to generate output token sequences.

The server receives, as output from the generative AI model, a response packet containing the generated tokens.

The server decodes the tokens into human-readable text and obtains proposal information that includes at least a spatial layout description, installed article layout descriptions, and installed device selection information.

### Step 7:

The server parses the proposal information into structured proposal data.

The server receives, as input, the free-form textual proposal information from Step 6.

The server applies parsing algorithms, including rule-based segmenters and pattern matchers, to identify sections such as an overview, floor plan descriptions, furniture placement, and appliance recommendations.

The server extracts data items, such as room types, dimensions, adjacency relationships, furniture types, positions, device types, and device performance attributes.

The server organizes these data items into structured entities, such as room objects, installed article objects, and installed device objects, each with attribute fields and layout parameters.

The server outputs structured proposal data stored under a proposal identifier in the storage apparatus.

### Step 8:

The server generates display data for two-dimensional and/or three-dimensional visualization.

The server takes, as input, the structured proposal data from Step 7.

The server assigns coordinates to room objects based on relative sizes and adjacency relationships and computes approximate geometries for walls, doors, and windows.

The server calculates positions and orientations for installed articles and installed devices within the spatial layout, ensuring that elements do not overlap and that minimum distances and access constraints are satisfied.

The server builds a two-dimensional representation, such as a floor plan with symbolic icons, and, when required, a three-dimensional scene graph with geometry, transformation matrices, and material parameters.

The server outputs display data in a format suitable for rendering by the terminal, and associates the display data with the corresponding proposal identifier.

### Step 9:

The server transmits the proposal information and the display data to the terminal.

The server receives, as input, a request from the terminal for proposal retrieval, including the proposal identifier.

The server retrieves the textual proposal information and the corresponding display data from the storage apparatus.

The server packages the proposal information and the display data into a response message and sends this message via the communication interface to the terminal.

The terminal receives, as output from the server, the textual proposal information and the visualization data.

### Step 10:

The terminal renders the proposal information and display data for the user.

The terminal takes, as input, the textual proposal information and the associated display data received in Step 9.

The terminal uses its graphics subsystem to draw a two-dimensional floor plan and, when applicable, to reconstruct a three-dimensional view based on the scene graph or geometry descriptions.

The terminal displays textual descriptions in an organized layout, grouping floor plan details, furniture layouts, and device recommendations into separate sections.

The terminal renders interactive controls, such as zoom, rotation, and selection tools, to allow the user to inspect the living space layout and the placement of installed articles and installed devices.

The terminal outputs a combined visual and textual representation of the proposal on the display device.

### Step 11:

The user evaluates the proposal and provides approval or change request information.

The user observes, as input, the rendered proposal on the terminal, including floor plans, interior layouts, and lists of devices.

The user performs interaction operations using the input device, such as selecting options to approve the proposal, typing comments that specify desired changes, or adjusting parameters such as budget or number of rooms.

The terminal captures these operations, converts them into digital data representing approval information or change request information, and prepares this data for transmission.

The terminal outputs user decision data, which the server receives as input for further processing.

### Step 12:

The server updates the prompt sentence and structured proposal data based on change request information.

The server receives, as input, change request information from the terminal and the corresponding proposal identifier.

The server identifies which structured entities are affected by the requested changes by matching the change request information against room, furniture, and device objects.

The server updates the structured proposal data in memory to reflect provisional changes and generates a new description of differences.

The server constructs an updated prompt sentence that summarizes both the original requirements and the specific requested revisions, using string-processing operations to integrate the changes into a coherent natural-language instruction.

The server outputs an updated prompt sentence and updated control information to be used as new request information for the generative AI model.

### Step 13:

The server regenerates proposal information using the generative AI model.

The server takes, as input, the updated prompt sentence and control information from Step 12.

The server tokenizes the updated prompt, assembles a new request packet, and sends this packet to the generative AI model via the communication interface.

The generative AI model produces a revised set of output tokens, which the server decodes into textual proposal information.

The server parses and converts this revised proposal information into updated structured proposal data using the same parsing mechanisms as in Step 7.

The server outputs a revised proposal record, which can be retrieved and displayed by the terminal in subsequent iterations.

### Step 14:

The server processes approval information and prepares data for external information processing apparatuses.

The server receives, as input, approval information from the terminal for a selected proposal identifier.

The server retrieves the final structured proposal data, including residential space information, installed article information, and installed device information.

The server extracts subsets of this data tailored for external apparatuses, such as a list of rooms and areas for contracting, a bill of materials for installed articles, and a list of devices with specifications for installation.

The server formats these subsets into structured messages that conform to communication protocols or application programming interfaces used by the external information processing apparatuses.

The server outputs contract processing information, supply processing information, and installation processing information as separate message streams.

### Step 15:

The server coordinates with external information processing apparatuses and aggregates progress states.

The server sends, as input to external information processing apparatuses, the structured messages generated in Step 14.

The external information processing apparatuses perform their respective operations and return status messages indicating stages such as requested, scheduled, and completed.

The server receives these status messages and updates internal records of progress states for each category of processing.

The server aggregates the progress states into a summarized project status and stores this status under the user's project identifier.

The server outputs the aggregated progress information to the terminal so that the terminal can present up-to-date status to the user.

### Step 16:

The server acquires and applies emotion information to adjust system outputs.

The terminal, or an associated sensor unit, captures user-related signals such as facial images, voice characteristics, or interaction patterns and generates emotion information by applying an emotion recognition algorithm.

The server receives, as input, emotion information associated with a particular user session.

The server evaluates the emotion information, for example by mapping it to categories such as satisfaction or confusion, and determines adjustment parameters for content and expression format of prompt sentences or proposal information.

The server modifies subsequent prompt sentences to request more detailed explanations, simplified language, or alternative layouts depending on the detected emotional state.

The server also adjusts the presentation style of proposal information, such as highlighting changes more prominently when confusion is detected.

The server outputs adapted prompt sentences and adapted proposal information, which are then used in further interactions with the generative AI model and in displays at the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional housing and interior recommendation systems generally apply fixed rule sets or static filters to user profile data to generate proposals. These systems typically do not integrate multimodal user inputs such as facial expressions, voice tone, in-store behavior, and iterative feedback into a unified computational workflow. As a result, the systems cannot adequately capture the user's real-time emotional state, evolving preferences, and situational context, and therefore produce recommendations that feel generic or inappropriate. This leads to low user satisfaction and inefficient selection of dwellings, layouts, movable objects, and electric power utilization devices.

Furthermore, in known systems, the interaction between a user interface, a recommendation engine, and a product database is loosely coupled. The server often treats a generative AI model, if used at all, as a simple text generator, without dynamically constructing prompt sentences from structured profile data and emotional data, or without systematically mapping natural-language outputs back to catalog items. This disconnect causes several technical problems: (i) redundant or irrelevant AI outputs that cannot be concretely realized; (ii) multiple, separate passes of manual filtering; and (iii) increased processing time and network traffic due to inefficient data exchanges and repeated, unstructured calls to the AI service.

In addition, existing systems that support augmented reality visualization or in-store navigation typically operate as standalone front-end utilities. These utilities often perform local 3D placement or simple waypoint guidance without integrating higher-level recommendation logic or the generative AI model. As a consequence, the AR display and navigation paths are not synchronized with the recommendation engine's outputs, and do not reflect the user's current emotional state or feedback. This fragmentation results in duplicated computations across client and server, inconsistent data representations for layouts and item positions, and difficulty in scaling the system to support multiple users and large product catalogs.

There is therefore a need for an improved computer-implemented system that tightly integrates (i) collection and analysis of user emotional information from image and audio data, (ii) generation of structured prompt sentences from combined user profile and emotional data, (iii) invocation of a generative AI model based on those prompt sentences, (iv) mapping of AI-generated proposal information to actual product and property records in storage, (v) optimization of proposal content based on emotional information, and (vi) production of coherent two-dimensional and augmented reality display data and in-store navigation guidance. Such a system should reduce redundant computations, lower the number of external AI calls, and maintain a consistent internal representation of recommendation states, thereby improving overall computational efficiency, accuracy of mapping between natural-language outputs and catalog data, and responsiveness of the user experience.

The specific processing by the specific processing unit 290 of the data processing device 12 in Application Example 2 is realized by the following means.

The present invention provides a server comprising a processor and a memory storing instructions that, when executed by the processor, cause the processor to generate, and transmit to an information processing terminal, a user interface for receiving user information including at least a desired residential area, a lifestyle, and preferences; to obtain image data and audio data from an image acquisition device and an audio acquisition device associated with the information processing terminal or with the server, to determine an emotional state of a user based on the image data and the audio data, and to store emotional information in association with the user information; to analyze the user information and the emotional information to generate, in a deterministic template-based manner, a prompt sentence in natural language describing the desired residential area, the lifestyle, the preferences, and the emotional state of the user, the prompt sentence being formatted as a structured input for a generative AI model; to input the prompt sentence into the generative AI model and obtain proposal information relating to a dwelling, an internal spatial configuration, movable objects, and electric power utilization devices, and to parse an output of the generative AI model to produce structured proposal data; to refer to a storage device that stores product information relating to the dwelling, the internal spatial configuration, the movable objects, and the electric power utilization devices, and, using the structured proposal data as a key, to search for and extract a group of candidate real products corresponding to the proposal information; to evaluate the group of candidate real products based on the emotional information and to optimize the proposal information by adjusting at least one attribute including a color tone, an arrangement style, and a functional characteristic, in a manner that re-ranks or filters the candidate real products; to generate display data that encodes two-dimensional layout representations and augmented reality placement parameters for visually presenting the dwelling, the internal spatial configuration, the movable objects, and the electric power utilization devices according to the optimized proposal information, and to transmit the display data to the information processing terminal; to update the prompt sentence and internal proposal state in response to an additional request or a modification request received from the information processing terminal, and to repeatedly perform proposal generation using the generative AI model and optimization based on the emotional information while maintaining a unified internal representation of user state and proposal state; and to calculate a placement position of at least one item included in the group of candidate real products in a real space based on item identification information and position information in the real space received from the information processing terminal, and to transmit guidance information defining the placement position or a movement route to the information processing terminal. This enables the server to implement a tightly coupled, stateful recommendation pipeline in which emotional analysis, prompt sentence generation, generative AI inference, catalog mapping, proposal optimization, AR visualization, and navigation guidance are executed as coordinated computational steps, thereby reducing redundant processing, decreasing latency in generating and updating recommendations, improving the accuracy with which natural-language outputs are bound to concrete catalog entries, and enhancing the overall performance and scalability of the computer system.

The term “system” refers to a combination of hardware and software components including at least a processor, a memory, one or more communication interfaces, and associated external devices, configured to execute the processing described in the claims.

The term “processor” refers to a hardware computation unit, such as a central processing unit, a graphics processing unit, or a dedicated logic circuit, that executes instructions stored in a memory to perform data processing operations.

The term “memory” refers to a hardware storage device, such as a semiconductor memory, a magnetic storage device, or an optical storage device, that stores instructions and data for execution by the processor.

The term “information processing terminal” refers to a user-operated electronic apparatus, such as a mobile communication device, a tablet device, a wearable device, or a general-purpose computer, that communicates with the server and provides input and output interfaces for the user.

The term “user interface” refers to a set of display screens, input fields, controls, and interaction elements presented on the information processing terminal, enabling the user to input information and receive information from the system.

The term “user information” refers to data indicating at least a desired residential area, a lifestyle, and preferences of a user, and may further include factors such as family structure, hobbies, budget, and working style.

The term “desired residential area” refers to a geographic region or locality in which the user wishes to reside, such as a city, a district, or a neighborhood.

The term “lifestyle” refers to a pattern of living of the user, including habits, work style, activity level, and daily routines that influence requirements for dwellings, internal spatial configurations, movable objects, and electric power utilization devices.

The term “preferences” refers to subjective choices or likes of the user, including at least design styles, color tones, functional priorities, and other selection criteria for dwellings, internal spatial configurations, movable objects, and electric power utilization devices.

The term “image acquisition device” refers to a hardware component such as a camera or an image sensor that captures visual information, including a user's face or surrounding environment, and outputs image data.

The term “audio acquisition device” refers to a hardware component such as a microphone or an audio sensor that captures sound, including the user's voice or ambient audio, and outputs audio data.

The term “image data” refers to digital data representing captured visual information, including at least still images or video frames suitable for analysis of facial expressions or environmental context.

The term “audio data” refers to digital data representing captured sound, including at least voice signals, tone, and prosody used for analysis of the user's emotional state or intent.

The term “emotional state” refers to an inferred psychological condition of the user, such as joy, sadness, calmness, stress, or excitement, determined based on analysis of image data, audio data, or both.

The term “emotional information” refers to data representing at least one emotional state of the user, including categories and confidence scores, stored in association with the user information and used for adjusting proposal information.

The term “prompt sentence” refers to a natural-language instruction text generated by the processor based on the user information and the emotional information, formatted for input into a generative AI model to cause the model to output proposal information.

The term “generative AI model” refers to a machine learning model that receives a prompt sentence as input and outputs generated content, including at least natural-language text describing proposals for a dwelling, an internal spatial configuration, movable objects, and electric power utilization devices.

The term “proposal information” refers to data, derived from an output of the generative AI model, describing one or more recommended dwellings, internal spatial configurations, movable objects, and electric power utilization devices, prior to mapping to specific catalog items.

The term “dwelling” refers to a physical living space, such as a house, an apartment, or another residential structure, that can be proposed to the user as a living environment.

The term “internal spatial configuration” refers to a layout of spaces inside a dwelling, including positions and dimensions of rooms, corridors, and functional areas, and relationships among these spaces.

The term “movable objects” refers to movable physical items usable within a dwelling, including at least furniture, decorative items, and other non-fixed goods.

The term “electric power utilization devices” refers to electrical equipment used in a dwelling, including at least home appliances and electronic devices that consume electric power in operation.

The term “structured data” refers to data organized according to a defined schema, such as key-value pairs, lists, or tabular entries, which is produced by parsing the output of the generative AI model to facilitate subsequent processing and database matching.

The term “storage device” refers to a hardware unit or subsystem, such as a database system or non-volatile memory, that stores product information related to dwellings, internal spatial configurations, movable objects, and electric power utilization devices.

The term “product information” refers to data describing actual items that can be provided to a user, including at least identifiers, dimensions, colors, styles, functional characteristics, prices, availability, and images.

The term “candidate real products” refers to a group of actual items retrieved from the storage device that correspond to, or match, the proposal information derived from the generative AI model.

The term “color tone” refers to a visual attribute related to the color characteristics of a product or a space, including at least hue, brightness, and saturation, used for adjusting proposals in response to emotional information.

The term “arrangement style” refers to a pattern or manner of placing movable objects and electric power utilization devices within an internal spatial configuration, including alignment, densities, and proximities among objects.

The term “functional characteristic” refers to a property of a product or configuration related to its practical use, including capacity, performance level, energy efficiency, and special functions.

The term “optimize the proposal information” refers to modifying or re-ranking the proposal information and corresponding candidate real products based on the emotional information and other constraints, such that attributes including at least color tone, arrangement style, and functional characteristic are adjusted to better match the user's state and preferences.

The term “display data” refers to data generated by the processor for output by the information processing terminal, including at least layout drawings, object positions, and rendering parameters for two-dimensional or augmented reality presentation.

The term “two-dimensional display” refers to a mode in which proposed dwellings, internal spatial configurations, movable objects, and electric power utilization devices are displayed on a flat screen, such as a monitor or mobile device display, using two-dimensional graphics.

The term “augmented reality display” refers to a mode in which virtual representations of dwellings, internal spatial configurations, movable objects, or electric power utilization devices are superimposed on a real-world view captured by a camera, using position and orientation information to align virtual and real elements.

The term “additional request” refers to a user-initiated query or command transmitted from the information processing terminal that asks for new or extended proposal information, without necessarily modifying previously input user information.

The term “modification request” refers to a user-initiated instruction transmitted from the information processing terminal that specifies changes to existing proposal information, such as altering item size, style, or functional requirements.

The term “item identification information” refers to data that uniquely identifies an item, such as a product code, barcode, identifier string, or catalog number, transmitted from the information processing terminal to the server.

The term “position information in the real space” refers to data that indicates a location or pose of the information processing terminal or of an item in a physical environment, obtained from sensors such as position detection devices or from indoor position estimation processing.

The term “placement position” refers to a position and, optionally, an orientation in a real or virtual space at which an item is to be arranged or displayed, as calculated by the processor.

The term “guidance information” refers to data describing at least one of a placement position or a movement route, formatted so that the information processing terminal can present instructions or visual cues for guiding the user within a real environment.

The term “external business entity” refers to an organization or service provider external to the system that engages in at least one of concluding contracts for dwellings and arranging installation of internal spatial configurations, movable objects, and electric power utilization devices.

The term “contract information” refers to data necessary for establishing a legal or commercial agreement between the user and an external business entity, including at least selected items, terms, and user identification.

The term “installation instruction information” refers to data that describes how selected movable objects and electric power utilization devices are to be delivered, assembled, and placed in a dwelling according to the optimized proposal information.

The term “schedule information” refers to data indicating planned times or dates for executing contracts, deliveries, or installations related to selected dwellings, internal spatial configurations, movable objects, and electric power utilization devices.

The term “execution status information” refers to data indicating a progress state of contract processing, delivery, or installation operations performed by an external business entity, such as pending, in progress, or completed.

The term “position detection device” refers to a hardware sensor or subsystem, such as a satellite positioning receiver, a wireless localization module, or an inertial measurement unit, that outputs information used to determine a location of the information processing terminal.

The term “indoor position estimation result” refers to a computed position of the information processing terminal within an indoor environment, obtained by processing signals such as wireless beacons, visual features, or sensor data.

The term “movement route” refers to a calculated path from a current position of the user to one or more target positions, such as positions of candidate real products, represented as a sequence of waypoints or navigation instructions.

The term “physical facility” refers to a real-world environment including at least a commercial space, store, showroom, or residential property, in which candidate real products may be located or displayed.

In one embodiment, a server implements the claimed system by executing a program stored in a memory and running on a processor such as a multi-core central processing unit and, optionally, a graphics processing unit. The server communicates with one or more terminals over a network such as the Internet using a communication interface. The terminals include, for example, smartphones, tablet devices, wearable devices such as smart glasses, and general-purpose computers. Each terminal includes at least a display unit, a touch or pointing input unit, a camera as an image acquisition device, a microphone as an audio acquisition device, a position detection unit such as a positioning receiver or a wireless localization module, and a local memory.

The server uses a general-purpose operating system, such as a server-class operating system, and hosts an application implemented for example in a language such as Python or Java running on top of a web framework such as a web application framework. The server further uses a database management system such as a relational database to store user information, emotional information, proposal information, and product information. The server also accesses a generative AI model, for example a transformer-based language model, via an application programming interface, and uses an emotion recognition engine implemented by a convolutional neural network or a recurrent neural network to determine an emotional state from image data and audio data.

The terminal executes an application (native or web-based) that presents a user interface received from the server. The terminal displays input fields and selection components allowing a user to input user information including at least a desired residential area, a lifestyle, and preferences. The terminal acquires multimedia data, including still images or video frames of the user's face through the camera and audio samples of the user's voice through the microphone. The terminal transmits the user information and multimedia data to the server over a secure communication protocol.

The server analyzes the user information by parsing structured fields, such as a desired residential area, preferred design style, family composition, hobbies, and work style, from a structured data representation, such as a JavaScript Object Notation object or form-encoded payload, stored in memory. The server normalizes textual fields using a tokenizer and normalizer, and maps region names to normalized codes using a region master table stored in the database. The server records the normalized user information in user profile records with fields including at least a user identifier, desired residential area code, lifestyle attributes, style preferences, and timestamp.

The server analyzes the multimedia data by invoking an emotion recognition module. In one embodiment, the server employs a convolutional neural network trained on facial expression datasets to classify facial images into discrete emotion categories, such as joy, sadness, anger, fear, surprise, and neutrality, and to output a probability distribution over these categories.

The server also employs an acoustic model, such as a recurrent neural network or temporal convolutional network, to analyze audio features including pitch, energy, spectral characteristics, and speaking rate, to further infer the user's emotional state and intensity. The server extracts features such as facial landmarks, action units, mel-frequency cepstral coefficients, and prosodic contours, and concatenates them into a feature vector. The server feeds the feature vector into a learned classifier that outputs probabilities for each emotion category. The server then stores the resulting emotional information, including the most likely emotional category, the confidence score, and a timestamp, in an emotion information table linked to the user profile record.

The server generates a prompt sentence in natural language by combining the user information and the emotional information according to predefined templates and rules. The server stores a prompt generation module that receives normalized user attributes and emotion categories as input and outputs a string that conforms to a predetermined structure, ensuring consistent phrasing and explicit inclusion of necessary attributes. For example, when the user inputs that the desired residential area is a specific district, the lifestyle corresponds to remote work and gardening as a hobby, and the emotion recognition module determines that the user is joyful, the server generates a prompt sentence such as: “The user wants to live in Tokyo, Shibuya-ku. The preferred interior style is modern. The family consists of 2 adults and 2 children. The user's hobby is gardening, and the user works remotely 3 days a week. The current emotion is joy. Please propose several candidate dwellings, detailed room layouts, furniture sets, and home appliances that match a modern style, support remote work, and include space for gardening. Output the proposal in a structured and clear way.”

The server uses this prompt sentence as an input to a generative AI model. In one embodiment, the generative AI model is a transformer-based language model comprising multiple self-attention layers, feed-forward networks, and layer normalization modules. The model parameters are learned using supervised or self-supervised training on large-scale text corpora. During training, the model uses a cross-entropy loss between predicted and actual tokens. During inference, the server sends the prompt sentence as a sequence of tokens to the model via an application programming interface, specifies decoding parameters such as temperature, top-k or top-p sampling thresholds, and maximum output length, and receives generated text that describes proposal information.

The server executes a parser module that processes the natural-language output of the generative AI model and converts it into structured proposal data. The parser module uses pattern recognition, such as regular expression matching and rule-based segmentation, or a secondary lightweight model, to detect sections corresponding to dwellings, internal spatial configurations, movable objects, and electric power utilization devices. The server assigns identifiers to each proposed dwelling and each proposed object, and stores attributes such as room types, dimensions (if provided), style descriptors (for example, “modern,” “minimalist,” “warm”), and functional descriptors (for example, “remote work friendly,” “child-safe,” “energy efficient”) in a proposal information table.

The server retrieves product information from a storage device by executing database queries.

The product information comprises records for dwellings, floor plan templates, furniture items, and electrical appliances, each record including a product identifier, dimensions, style tags, color attributes, energy ratings, price, and availability status. The server maps the textual attributes in the structured proposal data to specific product records using a similarity computation. For example, the server computes vector representations of both product descriptions and generative AI model outputs using a sentence encoding model, and then computes cosine similarity scores between these vectors. The server selects product records with similarity scores above a threshold as candidate real products corresponding to the proposal information and stores them in a candidate group table linked to the proposal.

The server optimizes the proposal information by using the emotional information as a re-ranking and filtering signal. For example, when the emotional information indicates that the user is stressed, the server increases weights associated with product attributes such as calm color tones, high comfort ratings, and minimalistic layouts, while decreasing weights associated with intense color schemes or cluttered arrangements. The server uses a scoring function that takes as inputs the similarity score between product and proposal, and features derived from the emotional information, and outputs an overall ranking score. The server then selects top-ranked items in each category (dwelling, layout, furniture, appliances) as part of an optimized proposal, and it may discard items with scores below a threshold.

The server generates display data for two-dimensional and augmented reality presentation on the terminal. The server converts optimized layout descriptions into a structured layout representation, for example, a graph of rooms and connections with positions expressed in a local coordinate system. The server assigns coordinates and orientations to movable objects and electric power utilization devices within each room, using rules derived from the generative AI model output, such as recommended distances from walls, relative positions to windows, and walking path clearances. The server then encodes this information in a format that can be interpreted by a rendering engine on the terminal.

The terminal receives the display data and uses a graphics library to render two-dimensional floor plans with icons representing movable objects and electric power utilization devices.

When augmented reality is used, the terminal employs an augmented reality software development kit which detects planes, such as floors and walls, from camera images, estimates the pose of the terminal, and maps the server-provided coordinates into the real-space coordinate system. The terminal then draws three-dimensional models of furniture and appliances at the indicated placement positions in the camera view, allowing the user to see a realistic overlay of the proposed arrangement in the actual environment.

The server updates the prompt sentence and the internal proposal state in response to user feedback. When the user interacts with the terminal to modify a proposal, such as requesting a smaller sofa, a different color palette, or more storage in a bedroom, the terminal transmits modification requests to the server in structured form. The server merges these modification constraints into the user information and current proposal state, and generates a new prompt sentence that explicitly encodes the changes. For example, when the user requests more storage, the server may generate a prompt sentence such as:

“The user prefers a smaller sofa and more storage space in the bedroom. Please revise the previous plan and propose a new layout and furniture list that satisfy these requirements while keeping the modern style.”

The server then repeats the generative AI model invocation, parsing, mapping, and optimization steps. Because the server maintains a unified internal representation of user profile, emotional information, and proposal state, the server avoids inconsistent partial updates and redundant full recomputation. The server can compute differences between consecutive proposals to reuse mapping results and restrict updates to changed parts, thereby reducing computational load and network traffic.

The server also calculates placement positions of items based on information obtained from the terminal in a real space. When the user scans a product in a physical store using the camera, the terminal acquires an item identification code, such as a barcode or quick response code, and sends it together with local position information, such as the position of the terminal relative to store reference coordinates. The server looks up product dimensions and category from the storage device, generates a prompt sentence describing the scanned item and the target room, and requests from the generative AI model a qualitative arrangement strategy. For example, the server may generate a prompt sentence such as:

“The user has scanned a modern-style sofa with dimensions 200 cm by 90 cm. The living room is approximately 20 square meters and rectangular. Please propose an optimal placement for the sofa relative to the television, windows, and walking paths. Describe the position in natural language and give high-level rules for distances and angles.”

The server receives placement instructions from the generative AI model, including recommended positions such as “centered opposite the television with at least 80 cm clearance behind,” converts them into numeric coordinates in the store or home coordinate system using layout information, and sends guidance information specifying these positions to the terminal. The terminal then renders an augmented reality marker in the store, or a three-dimensional preview in the user's home, at the calculated placement position.

The server further coordinates with external business entities by transmitting contract and installation instruction information over a communication network. When the user accepts an optimized proposal and selects specific dwellings, layouts, furniture items, and appliances, the terminal sends acceptance data to the server. The server compiles contract information, generates structured installation instruction information that includes coordinates and orientation for placing each item according to the optimized layout, and transmits these data to external systems operated by housing providers, furniture suppliers, or installation service providers. The server receives schedule information and execution status information, stores them in the database, and notifies the terminal so that the user can track the progress.

The described configuration provides technical improvements over conventional systems. By generating deterministic, structured prompt sentences from user information and emotional information, the server significantly reduces the entropy of inputs to the generative AI model and constrains the output space. This structured prompting improves the consistency and reliability of the model outputs and facilitates automated parsing into structured data, thereby reducing parsing errors and manual post-processing. The server uses a specific data flow and data structures for proposals and product mappings, which enable efficient indexing and retrieval from the storage device, and make it possible to reuse partial results when the user modifies only certain aspects of a proposal.

The server's use of emotional information as part of the scoring and optimization process introduces technical rules that cannot be achieved by simple human intuition at scale. The server uses numeric emotion scores as features in a scoring function that adjusts ranking weights. This form of integration between continuous emotional variables and discrete product attributes improves the accuracy of mapping between user state and product characteristics, and allows the system to consistently optimize proposals in a way that reduces mismatches and increases the probability that selected items will align with the user's current needs. The server also optimizes communication patterns by reducing repeated calls to the generative AI model: by maintaining internal state and updating prompt sentences incrementally, the server can limit calls to segments of a proposal that actually change, thereby lowering network usage and latency.

From a computational standpoint, the combination of neural network-based emotion recognition, transformer-based natural language generation, and structured mapping to product records within one coordinated pipeline leads to improved processing efficiency. The server offloads heavy perceptual tasks, such as emotion classification, to specialized neural models and uses structured intermediate representations that enable low-cost deterministic operations (such as template construction, database matching, and ranking) between AI model invocations. As a result, the server reduces overall computational cost per user session while improving the granularity and quality of proposals.

In alternative embodiments, the server may employ different network architectures or training methods for the emotion recognition models and the generative AI model. For example, the server may use a multi-task learning scheme in which a single backbone network jointly predicts emotion categories and acoustic-emotional features. The server may also adapt the generative AI model through fine-tuning on domain-specific texts describing housing, interior design, and appliances, using supervised learning with domain labels and optimizing using gradient-based methods and regularization to avoid overfitting. The server may further employ data augmentation schemes for emotion recognition, such as random cropping of facial images, adding noise to audio waveforms, and time stretching, to increase robustness to variations in lighting, pose, and background noise.

In another embodiment, part of the emotion recognition processing is performed on the terminal. The terminal executes a lightweight neural network, for example a reduced convolutional network, trained to extract emotion features from camera frames locally. The terminal sends only compact feature vectors or emotion scores to the server, thereby reducing network bandwidth requirements and preserving privacy by avoiding transmission of raw images. The server then integrates those scores as emotional information into the proposal optimization pipeline in the same way as when full image and audio data are used.

In yet another embodiment, the server uses a different similarity algorithm for mapping proposal information to product information, such as locality-sensitive hashing for large product catalogs, to accelerate nearest-neighbor searches. The server may also index products by multiple keys, including style vectors, functional tags, and color histograms, to improve retrieval accuracy. These variants further contribute to reduced latency and improved matching precision, and therefore to the overall technical effect of more responsive and accurate recommendation behavior.

As described above, the server, the terminal, and the user cooperate through specific hardware and software modules, defined data structures, and explicit processing rules to realize a system that integrates generative AI model outputs with emotion-aware optimization, structured product mapping, augmented reality visualization, and navigation guidance. This integration results in technical effects including reduced end-to-end latency, improved accuracy of mapping between natural-language proposals and concrete product records, lower communication overhead, and more efficient use of computational resources.

The system thus achieves an improvement in computer technology itself, beyond mere automation of human mental processes or conventional business operations.

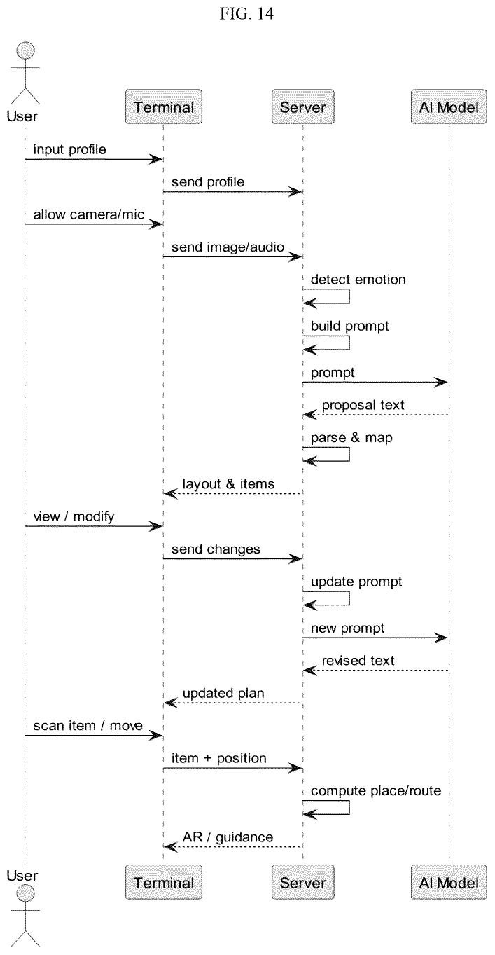

The following describes the processing flow using FIG. 14.

### Step 1:

User operates a terminal and opens an application or web page provided by the server.

User inputs basic user information including at least a desired residential area, lifestyle information, and preferences using text fields, selection boxes, and buttons.

Input: raw user inputs (text strings, selected options).

Output: a structured user information object held in the terminal memory (for example, a key-value map).

Terminal converts the raw inputs into a structured format by assigning each input field to a predefined key (for example, “region,” “style,” “family,” “hobby”), performs basic client-side validation (for example, checking that mandatory fields are not empty), and transmits the structured user information to the server via a network request.

### Step 2:

Server receives the structured user information from the terminal.

Server validates the received data (for example, checks that the region string matches a known pattern and that numeric fields such as family size and budget are parsable), and normalizes textual fields (for example, converting to lower case, trimming spaces, mapping synonyms to canonical terms).

Input: structured user information object from the terminal.

Output: normalized user profile data stored in a user profile record in a database.

Server executes database commands to insert or update a user profile table, where each column corresponds to an attribute such as desired residential area code, lifestyle category, style preference codes, and timestamp. The server generates a user identifier or session identifier and links it to the newly stored user profile.

### Step 3:

Terminal activates a camera and a microphone after obtaining permission from the user.

Terminal captures image frames of the user's face and audio samples of the user's voice while the user interacts with the interface.

Input: sensor signals from the camera and microphone.

Output: digitized image data (for example, frames in a compressed video format) and audio data (for example, pulse-code modulated samples or compressed audio packets).

Terminal may optionally perform local compression and noise reduction, and then sends either the raw or pre-processed image and audio data to the server together with identifiers that tie the multimedia data to the current user session.

### Step 4

Server performs emotion recognition using the received image and audio data.

Server extracts features from the image data by detecting facial landmarks, cropping the face region, resizing the images to a fixed dimension, and normalizing pixel values. Server extracts audio features using a short-time Fourier transform to calculate spectral properties, and then computes features such as mel-frequency cepstral coefficients and prosodic statistics.

Input: image data and audio data from the terminal.

Output: emotional information comprising at least one emotional category (for example, joy, sadness, stress), confidence values, and an associated timestamp.

Server feeds the extracted features into trained neural network models (for example, convolutional networks for images and recurrent or temporal convolutional networks for audio) and obtains probability distributions over emotion categories. Server selects the category with the highest probability as the current emotional state and stores the emotional information in an emotion table linked to the user profile in the database.

### Step 5:

Server constructs a prompt sentence for a generative AI model by combining the normalized user profile data and the emotional information.

Server retrieves the necessary attributes (for example, region code, style preference, hobby, work style, family size, current emotional state) from the database and passes them to a prompt-generation module. The module applies template rules to compose a coherent natural-language description that includes these attributes in a fixed structure.

Input: normalized user profile data and emotional information.

Output: a prompt sentence in natural language, stored as a text string.

Server generates, for example, a prompt sentence such as: “The user wants to live in Tokyo, Shibuya-ku. The preferred interior style is modern. The family consists of 2 adults and 2 children. The user's hobby is gardening, and the user works remotely 3 days a week. The current emotion is joy. Please propose several candidate dwellings, detailed room layouts, furniture sets, and home appliances that match a modern style, support remote work, and include space for gardening. Output the proposal in a structured and clear way.”

### Step 6:

Server sends the prompt sentence to a generative AI model via an application programming interface.

Server tokenizes the prompt sentence into a sequence of tokens according to the vocabulary of the generative AI model, attaches decoding parameters (for example, temperature, top-k threshold), and submits an inference request to the model-hosting service.

Input: prompt sentence text.

Output: generated text from the generative AI model that describes proposal information, returned as a sequence of tokens or a string.

Server receives the generated text, reconstructs it from tokens if necessary, and stores the raw output in memory for further processing.

### Step 7:

Server parses the generated text from the generative AI model into structured proposal data.

Server applies pattern recognition rules or a secondary lightweight parser model to detect labeled sections (for example, “Dwelling Proposals,” “Room Layouts,” “Furniture Recommendations,” “Appliance Recommendations”). The server then extracts items within each section, splits lines into attributes (for example, item name, room type, style descriptor), and assigns identifiers to each proposed element.

Input: generated text from the generative AI model.

Output: structured proposal data including separate collections of proposed dwellings, internal spatial configurations, movable objects, and electric power utilization devices.

Server stores the structured proposal data in internal data structures (for example, in-memory maps or database tables) with fields such as category type, descriptive text, style tags, functional tags, and reference to the originating prompt sentence.

### Step 8:

Server maps the structured proposal data to actual product and property records stored in a storage device.

Server retrieves product information from a database that includes items such as dwellings, floor plans, furniture, and appliances. Server converts textual attributes of both proposal entries and product records into vector embeddings using a sentence embedding model.

Server then computes similarity metrics such as cosine similarity for each pair (proposal item, product record).

Input: structured proposal data and product information from the storage device.

Output: a group of candidate real products for each proposal element, each candidate having an associated similarity score.

Server filters product records by similarity threshold, availability status, and, if necessary, price or size constraints. The server stores candidate lists for each proposal element as candidate groups in a mapping table, linking each proposal item identifier to one or more product identifiers with similarity scores.

### Step 9:

Server optimizes the proposal information using the emotional information.

Server retrieves the emotional information for the current session and forms a feature vector that encodes the emotional category and intensity. Server then calculates a ranking score for each candidate product using a scoring function that combines the similarity score, emotional features, and product attributes such as color tone, style tags, and functional characteristics.

Input: candidate groups with similarity scores and emotional information.

Output: optimized proposal information, including re-ranked lists of selected real products and updated attribute annotations.

Server adjusts ranks such that products whose attributes match emotional preferences (for example, calm color tones for stress, bright colors for joy) receive higher scores. The server may also replace or drop items whose attributes conflict with emotional requirements. The server produces an optimized set of selected dwellings, layouts, movable objects, and appliances and stores them as an optimized proposal record.

### Step 10:

Server generates display data based on the optimized proposal information.

Server transforms the selected layouts into numeric room geometries using assumed or retrieved dimensions, assigns relative positions to movable objects and appliances based on recommended distances and arrangements, and encodes this information in a structured layout model. The model includes room coordinates, object coordinates, object orientations, and rendering attributes such as icon type or three-dimensional model identifiers.

Input: optimized proposal information.

Output: display data encoding at least a two-dimensional layout representation and, when applicable, augmented reality placement parameters.

Server packages the display data in a format that the terminal rendering engine can interpret (for example, a JSON representation of rooms and objects with coordinates) and transmits it to the terminal via a network response.

### Step 11:

Terminal receives the display data and renders a two-dimensional or augmented reality representation.

Terminal converts the layout coordinates and object attributes into drawing commands. For two-dimensional mode, the terminal draws floor plan outlines and icons for movable objects and electric power utilization devices on the screen. For augmented reality mode, the terminal uses an augmented reality framework to detect surfaces in the camera view and transforms the server-provided coordinates into the real-world coordinate system.

Input: display data from the server and, for augmented reality, camera frames and sensor-based pose estimates.

Output: visual presentation of the proposed dwelling, internal spatial configuration, movable objects, and electric power utilization devices on the terminal display.

Terminal overlays virtual objects at calculated positions in the camera feed, providing the user with a realistic preview of the arrangement.

### Step 12:

User reviews the visualized proposal and provides feedback or modification requests.

User interacts with user interface elements such as check boxes, sliders, and text input fields to express preferences, for example requesting a smaller sofa, additional storage, or a different color scheme.

Input: current visual presentation and user actions on the terminal interface.

Output: structured modification requests indicating constraints or changes (for example, “sofa size: smaller,” “bedroom storage: increased,” “color tone: warmer”).

Terminal serializes the modification requests into a structured format and sends them to the server as part of an update request.

### Step 13:

Server updates the prompt sentence and the internal proposal state based on the modification requests.

Server combines the modification constraints with the previously stored user profile and optimized proposal information. Server adjusts internal flags and attributes to reflect the requested changes, and regenerates a prompt sentence that explicitly describes the modifications along with the base profile and emotional state.

Input: modification requests and stored user and proposal data.

Output: an updated prompt sentence and an updated internal state indicating constraints for the next proposal iteration.

Server then repeats the generative AI model invocation and subsequent parsing, mapping, and optimization steps, but may reuse parts of the previous mapping results to reduce computation, for example by only regenerating items affected by the modification requests.

### Step 14:

Terminal may acquire item identification information and position information in a real space when the user scans a product or moves within a physical facility.

User points the terminal camera toward a product or walks inside a store while carrying the terminal. Terminal reads an item code such as a barcode or quick response code using its camera and a decoding library, and obtains position information from a position detection device or indoor localization module.

Input: camera images containing item codes and localization signals from sensors or beacons.

Output: decoded item identification information and position information in the real space.

Terminal sends the item identification information and position information to the server to request guidance or placement suggestions.

### Step 15:

Server calculates placement positions and navigation guidance based on the received item identification information and position information.

Server retrieves product dimensions and style information from the storage device using the item identification information, and retrieves a store or room layout map that defines reference coordinates. Server computes a placement position by aligning the product dimensions and recommended clearances with free space coordinates, and computes a movement route from the user's current position to the target product or placement location using a path-finding algorithm.

Input: item identification information, position information, and product and layout data from the storage device.

Output: guidance information that indicates at least one of a placement position and a movement route.

Server encodes the placement position and movement route in a format suitable for visualization and transmits this guidance information to the terminal. The terminal then presents directional cues or augmented reality markers guiding the user within the physical environment.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

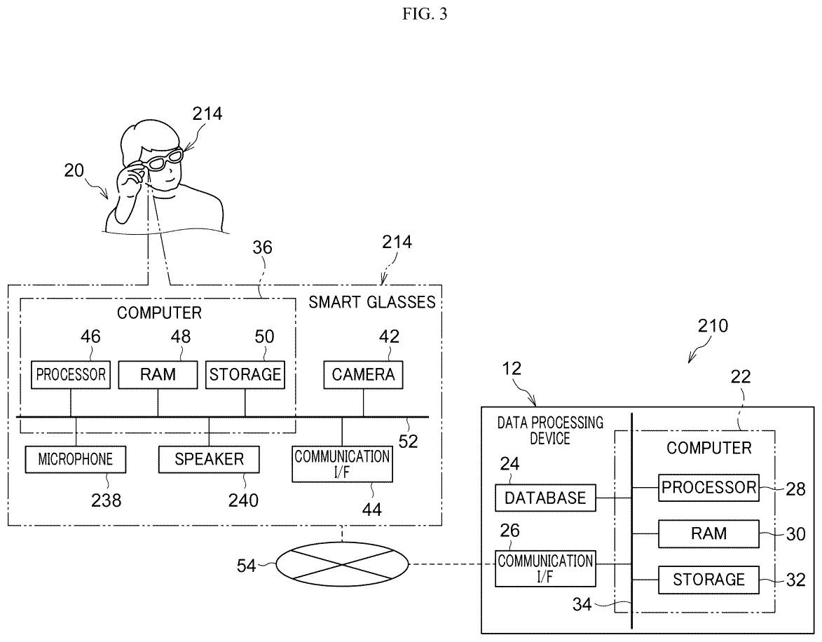

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

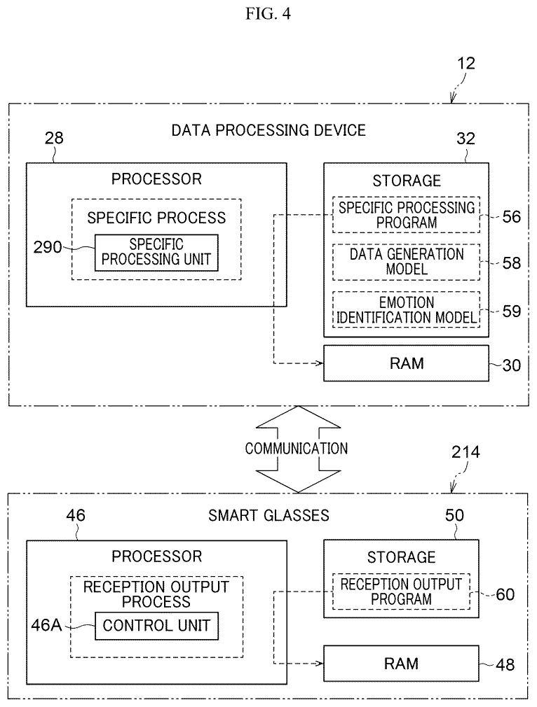

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

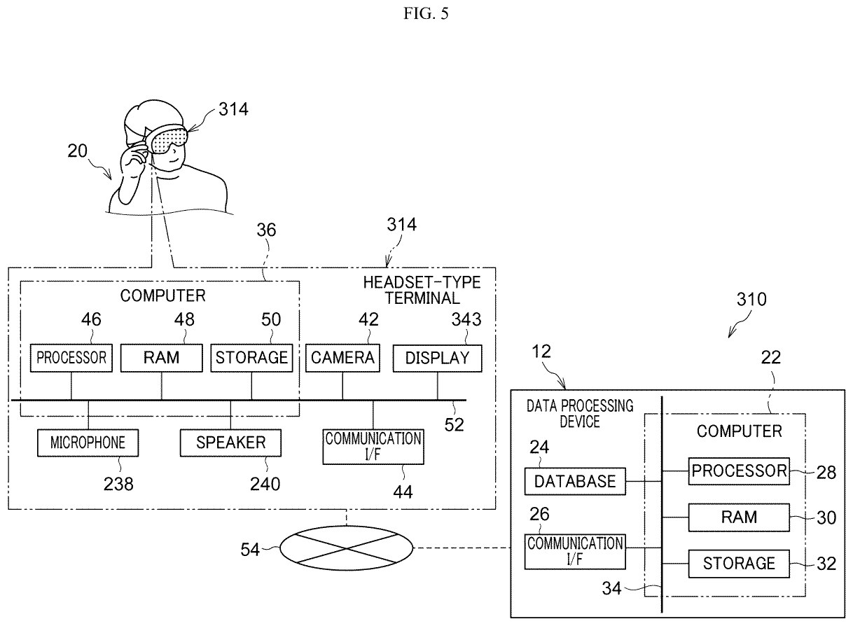

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

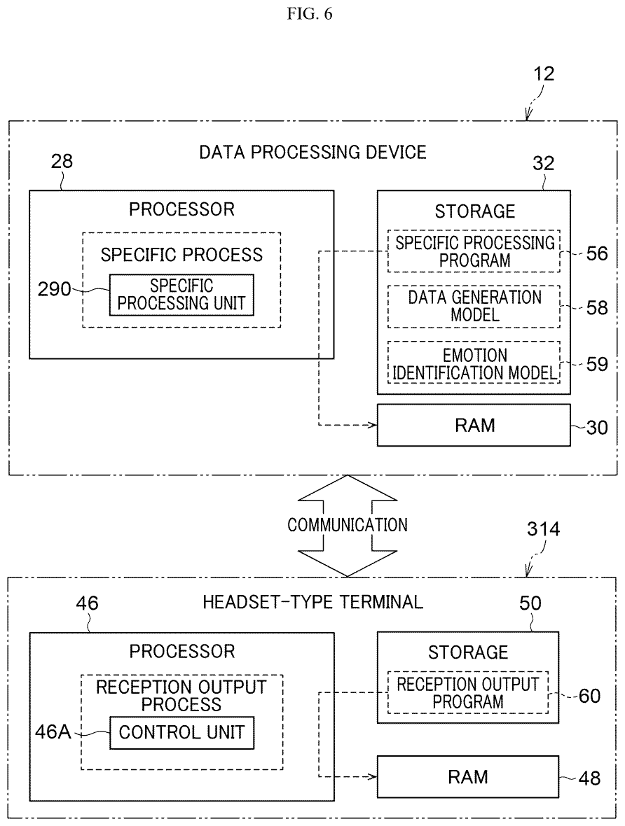

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

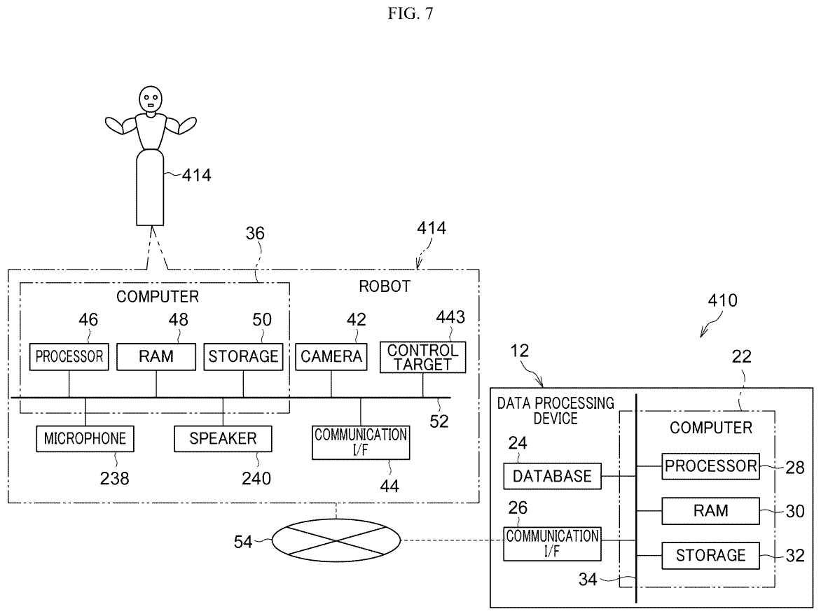

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

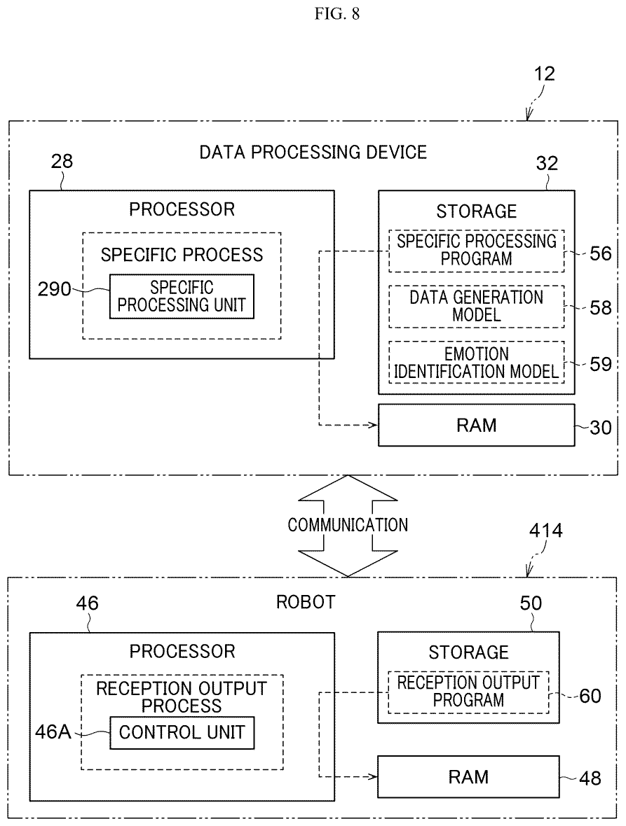

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

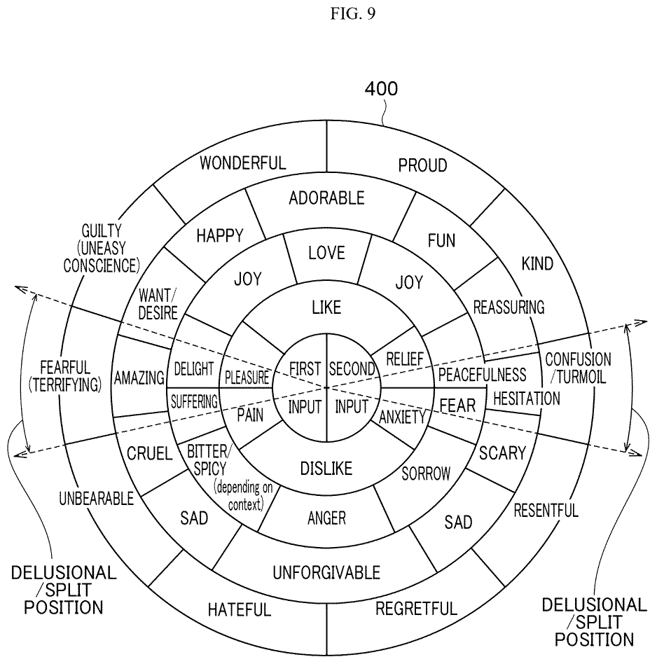

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

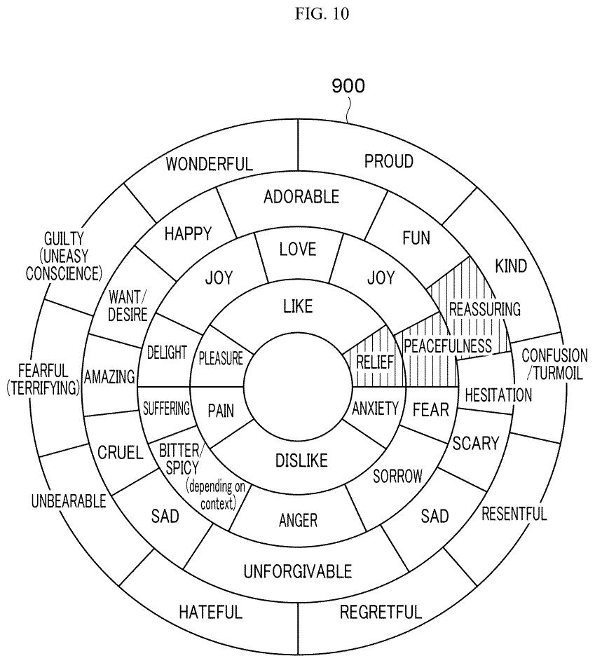

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide, on an information processing apparatus, a user interface for receiving an input of a residential area desired by a user,
receive residential area information transmitted from a terminal and perform normalization and verification of the residential area information,
search, based on the normalized residential area information, a set of real estate information stored in a storage device and extract candidate real estate information,
acquire, from the storage device, a set of spatial layout information associated with the candidate real estate information and determine layout information including room types and floor areas,
search, based on the determined layout information, a set of furnishing information and select furnishing candidates suitable for dimensions and intended uses of respective rooms,
search, based on the selected furnishing candidates and the layout information, a set of electric appliance information and select electric appliance candidates suitable for conditions of the respective furnishings and the respective rooms,
store, in the storage device, user history information including an input history and a selection history of the user, and assign priorities to at least part of the real estate information, the layout information, the furnishing information, and the electric appliance information by using the user history information,
generate a prompt sentence for input to a generative information generation model based on the residential area information, the candidate real estate information, the layout information, the furnishing candidate information, the electric appliance candidate information, and the user history information,
cause the generative information generation model to operate on an external or internal information processing resource using the generated prompt sentence and thereby generate a residential environment configuration plan including a residence, a layout, furnishings, and electric appliances,
transmit the generated residential environment configuration plan to the terminal, cause the residential environment configuration plan to be presented via the user interface, receive a final selection result from the user, and update the user history information based on the final selection result, and
estimate an emotional state or preference tendency of the user based on at least one of user input content, user selection operations, and the user history information, and adjust at least one of the prompt sentence and contents of the residential environment configuration plan according to an estimation result.

### Supplementary 2

The system according to supplementary 1,
wherein the processor is configured to
refer to external provider management information based on the residence, the layout, the furnishings, and the electric appliances included in the residential environment configuration plan output from the generative information generation model, to identify supply entities and provision conditions, and to transmit and receive contract processing information and installation work information with the supply entities via a communication network so as to execute or arrange, for the user, a contract for the residence and provision and installation of the furnishings and the electric appliances.

### Supplementary 3

The system according to supplementary 1,
wherein the processor is configured to
acquire user position information from a position detection apparatus, acquire product arrangement information in a physical facility from the storage device based on the user position information, calculate a guidance route to arrangement positions of products corresponding to the furnishings and the electric appliances included in the residential environment configuration plan, and present navigation information indicating the guidance route on the user interface of the terminal.

### Application Example 1

### Supplementary 1

A system comprising a processor,
wherein the processor is configured to
provide, via an information input/output apparatus, a user interface through which a user inputs information indicating a desired residential region,
receive the residential region information transmitted from the information input/output apparatus, normalize the residential region information, and convert the normalized residential region information into geographic information,
search, based on the normalized residential region information, an information storage apparatus that stores real estate information, and acquire a set of candidate real estate information,
calculate, for the set of candidate real estate information, evaluation values using at least price information, area information, location information, building-age information, and user attribute information, and select a predetermined number of optimal real estate information items,
search, based on the selected optimal real estate information, an information storage apparatus that stores spatial layout information, evaluate spatial layout information with reference to user preference conditions, and select optimal spatial layout information,
search, based on room information and dimension information included in the optimal spatial layout information, an information storage apparatus that stores furniture information, extract furniture information that satisfies dimension conditions and user preference conditions, and generate a furniture configuration plan,
search, based on the furniture configuration plan including the furniture information and the room information, an information storage apparatus that stores electric apparatus information, extract electric apparatus information that satisfies dimension conditions, capacity conditions, and power-saving conditions, and generate an electric apparatus configuration plan,
generate a prompt sentence that integrates, at least in part, the optimal real estate information, the optimal spatial layout information, the furniture configuration plan, and the electric apparatus configuration plan as natural language information and structured data, transmit the prompt sentence to a generative AI model, and acquire response information including recommendation content or explanatory content from the generative AI model,
integrate the response information with the real estate information, the spatial layout information, the furniture information, and the electric apparatus information, generate proposal result information including recommended real estate, a recommended spatial layout, recommended furniture, and recommended electric apparatus, and transmit the proposal result information to the information input/output apparatus, and
receive selection information from the user regarding the proposal result information, and support a purchase process or a contract process for selected real estate, spatial layout, furniture, and electric apparatus.

### Supplementary 2

The system according to supplementary 1,
wherein the processor is configured to
generate the prompt sentence in a format that combines natural language text including at least the residential region information of the user, user attribute information, user preference information, and summary information of the real estate information, the spatial layout information, the furniture information, and the electric apparatus information, with structured data, and dynamically modify at least one of the evaluation values, the furniture configuration plan, and the electric apparatus configuration plan based on the response information acquired from the generative AI model.

### Supplementary 3

The system according to supplementary 1,
wherein the processor is configured to
associate the real estate information, the spatial layout information, the furniture information, and the electric apparatus information included in the proposal result information with display positions or guidance routes in a physical facility using user position information and facility position information, and cause the information input/output apparatus to perform guidance display or route guidance linked with the proposal result information.

### Example 2

### Supplementary 1

A system comprising a processor,
wherein the processor is configured to
acquire user requirement information, including at least a residential area, a residential structure, a spatial layout, an interior style, installed articles, installed devices, and budget conditions, via an input/output apparatus that provides an interface for a user to input requirements relating to a living space, and to store the acquired user requirement information as itemized structured information in a storage apparatus,
to convert, by string processing, the structured information into a natural-language prompt sentence, to add control information indicating at least a role, an output format, constraint conditions, and evaluation criteria of a generative information processing model to the prompt sentence, and to generate request information to be input to the generative information processing model,
to transmit the request information to the generative information processing model via a communication apparatus, and to receive proposal information, including at least spatial layout information, installed article layout information, and installed device selection information for the living space, the proposal information being generated by information processing executed by the generative information processing model on the basis of the prompt sentence,
to analyze the proposal information, to generate structured proposal data including at least attribute information, layout information, and required resource information for each element of the living space, to generate, on the basis of the structured proposal data, display data for two-dimensional display or three-dimensional display, and to present the proposal information and the display data to the user via the input/output apparatus,
to acquire, via the input/output apparatus, either approval information or change request information from the user, and, when the change request information is included, to generate an updated prompt sentence in which the change request information is reflected in the prompt sentence, to generate updated request information including the updated prompt sentence, and to retransmit the updated request information to the generative information processing model so as to cause the proposal information to be regenerated,
to, on the basis of the approval information, extract residential space information, installed article information, and installed device information from the structured proposal data, to execute communication with an external information processing apparatus, to exchange at least contract processing information, supply processing information, and installation processing information, thereby cooperatively executing business processing relating to acquisition of the living space, supply of the installed articles, and installation of the installed devices, and to aggregate progress states of the business processing and notify the progress states to the user via the input/output apparatus, and
to acquire emotion information indicating an emotional state of the user and to adjust at least one of content and expression format of the prompt sentence or the proposal information on the basis of the emotion information.

### Supplementary 2

The system according to supplementary 1,
wherein the processor is configured to
cause the input/output apparatus to provide a display function that visually displays, on the basis of the display data, at least the spatial layout of the living space and the layout of the installed articles, and an editing function that, in response to an input operation from the user, changes at least a part of the structured proposal data and automatically reflects a content of the change in the prompt sentence.

### Supplementary 3

The system according to supplementary 1,
wherein the processor is configured to
acquire position information from a positioning apparatus, derive, on the basis of the position information, a placement position in a physical space in which a physical object corresponding to at least one of the installed articles or the installed devices included in the structured proposal data is arranged, and output guidance information to the placement position via the input/output apparatus so as to provide a navigation function that guides the user to the physical object in the physical space.

### Application Example 2

### Supplementary 1

A system comprising a processor,
wherein the processor is configured to
generate, and transmit to an information processing terminal, a user interface that enables a user to input user information including at least a desired residential area, a lifestyle, and preferences,
obtain, from an image acquisition device and an audio acquisition device connected to the information processing terminal or to the system, image data and audio data, and determine an emotional state of the user based on the image data and the audio data, and store emotional information linked to the user information,
analyze the user information and the emotional information, and generate a prompt sentence in natural language describing at least the desired residential area, the lifestyle, the preferences, and the emotional state of the user, the prompt sentence being used as an input to a generative AI model,
input the prompt sentence into the generative AI model and obtain proposal information relating to a dwelling, an internal spatial configuration, movable objects, and electric power utilization devices, and parse the proposal information as structured data,
refer to a storage device that stores product information relating to the dwelling, the internal spatial configuration, the movable objects, and the electric power utilization devices, and, based on the proposal information and the product information, search for and extract a group of candidate real products corresponding to the proposal information,
evaluate the group of candidate real products based on the emotional information, and optimize the proposal information by adjusting at least one attribute including a color tone, an arrangement style, and a functional characteristic,
generate display data that causes the information processing terminal to visually present, via two-dimensional display or augmented reality display, placement of the dwelling, the internal spatial configuration, the movable objects, and the electric power utilization devices according to the optimized proposal information, and transmit the display data to the information processing terminal,
update the prompt sentence in response to an additional request or a modification request transmitted from the information processing terminal, and repeatedly perform proposal generation by the generative AI model and optimization based on the emotional information, and
calculate a placement position of an item included in the group of candidate real products in a real space based on item identification information and position information in the real space transmitted from the information processing terminal, and transmit guidance information relating to the placement position to the information processing terminal.

### Supplementary 2

The system according to supplementary 1,
wherein the processor is configured to, based on the optimized proposal information, transmit contract information and installation instruction information relating to a selected dwelling, a selected internal spatial configuration, selected movable objects, and selected electric power utilization devices to an external business entity via a communication network, receive schedule information and execution status information from the external business entity, and notify the information processing terminal of the schedule information and the execution status information.

### Supplementary 3

The system according to supplementary 1,
wherein the processor is configured to identify a current position of the user based on position information obtained from a position detection device of the information processing terminal and based on an indoor position estimation result, calculate a movement route according to a positional relationship between the current position and placement positions of items included in the group of candidate real products, and transmit guidance information indicating the movement route to the information processing terminal to support searching for items in a physical facility.

What is claimed is:

1. A system comprising:
circuitry configured to:
receive, via a communication interface coupled to a packet-switched network, query specification data from a terminal device, and apply a natural language processing model to the query specification data to extract a structured attribute vector comprising feature parameters and constraint parameters;
search a first database stored in a storage device using the structured attribute vector as a query key to extract a set of candidate item records, and retrieve configuration data associated with each candidate item record from the storage device;
apply a compatibility matching algorithm to select, from a second database, a first set of component candidates satisfying compatibility conditions with the configuration data, and apply a constraint satisfaction algorithm to select, from a third database, a second set of component candidates satisfying compatibility conditions with the first set of component candidates and the configuration data;
retrieve user history information comprising an input history and a selection history from the storage device, apply a weighted scoring function to the user history information to compute priority scores for the candidate item records and the component candidates, and rank the candidate item records and the component candidates according to the priority scores;
obtain emotion-state information of the user by processing input data received from the terminal device using an emotion recognition model to generate an emotion label and a preference tendency score, and construct a prompt sentence for a generative neural network model by encoding the structured attribute vector, the ranked candidate item records, the configuration data, the first set of component candidates, the second set of component candidates, the user history information, and the emotion label as input fields; and
transmit the prompt sentence to the generative neural network model to obtain a configuration plan, adjust a presentation content of the configuration plan based on the emotion label and the preference tendency score, and transmit the adjusted configuration plan to the terminal device via the communication interface.

2. The system according to claim 1, wherein the circuitry is configured to apply the natural language processing model by extracting named entity features and constraint features from the query specification data, and encoding the extracted features as standardized attribute fields in the structured attribute vector.

3. The system according to claim 2, wherein the circuitry is configured to verify the structured attribute vector against a reference dataset stored in the storage device, and to search the first database using the verified attribute fields as query keys to extract candidate item records satisfying one or more attribute filters derived from the user history information.

4. The system according to claim 3, wherein the circuitry is configured to retrieve configuration data comprising dimensional parameters and functional category labels for each candidate item record, and to apply the compatibility matching algorithm using the dimensional parameters and the functional category labels to select first component candidates satisfying dimensional and functional compatibility constraints.

5. The system according to claim 4, wherein the circuitry is configured to apply the constraint satisfaction algorithm using the selected first component candidates and the configuration data to select second component candidates satisfying pairwise compatibility conditions with the first component candidates and the dimensional parameters.

6. The system according to claim 1, wherein the circuitry is configured to compute the priority scores by applying the weighted scoring function assigning higher weights to item attributes corresponding to more recent selection events in the selection history, and lower weights to item attributes not represented in the input history.

7. The system according to claim 6, wherein the circuitry is configured to update the user history information based on a final selection result received from the terminal device, and to recompute priority scores for subsequent search operations based on the updated user history information.

8. The system according to claim 7, wherein the circuitry is configured to generate a training pair comprising the prompt sentence and the final selection result, and to store the training pair in the storage device for fine-tuning the generative neural network model on user-specific preference patterns.

9. The system according to claim 8, wherein the circuitry is configured to monitor a reconstruction error of an autoencoder model trained on normal-quality configuration plan data, and to initiate a re-generation operation when the reconstruction error exceeds a predetermined anomaly threshold.

10. The system according to claim 1, wherein the circuitry is configured to obtain the emotion-state information by processing at least one of voice signal data, facial image data, and interaction pattern data received from the terminal device using the emotion recognition model.

11. The system according to claim 10, wherein the circuitry is configured to adjust the presentation content of the configuration plan by modifying at least one of a quantity, a style, and an ordering of presented options based on the emotion label and the preference tendency score.

12. The system according to claim 11, wherein the circuitry is configured to modify the prompt sentence based on the emotion label to instruct the generative neural network model to adjust the generated configuration plan content in accordance with the emotion label and the preference tendency score.

13. The system according to claim 12, wherein the circuitry is configured to monitor changes in the emotion-state information over successive interaction turns and dynamically update the presentation content and prompt sentence parameters based on the monitored changes.

14. The system according to claim 1, wherein the circuitry is configured to store interaction history comprising prior prompt sentences, generated configuration plans, and final selection results, and to incorporate the interaction history into subsequently generated prompt sentences to maintain preference continuity across interaction sessions.

15. The system according to claim 14, wherein the circuitry is configured to retrieve, from the interaction history, a prior configuration plan associated with a matching structured attribute vector, and to include attributes of the prior configuration plan as preference context in a subsequently generated prompt sentence.

16. The system according to claim 1, wherein the circuitry is configured to receive location information of the user from a positioning sensor of the terminal device, and to generate navigation guidance data directing the user to a physical location of a selected component candidate based on the location information.

17. The system according to claim 16, wherein the circuitry is configured to receive in-store location data from the terminal device and to update the navigation guidance data in real time based on the in-store location data to guide the user within a physical facility.

18. A system comprising:
circuitry configured to:
receive, via a communication interface coupled to a packet-switched network, query specification data from a terminal device, apply a natural language processing model to extract a structured attribute vector comprising feature parameters and constraint parameters, and search a first database to extract candidate item records;
retrieve configuration data for each candidate item record, apply a compatibility matching algorithm to select first component candidates from a second database satisfying compatibility conditions with the configuration data, and apply a constraint satisfaction algorithm to select second component candidates from a third database satisfying compatibility conditions with the first component candidates;
retrieve user history information from a storage device, apply a weighted scoring function to the user history information to compute priority scores, and rank the candidate item records and the component candidates according to the priority scores;
obtain emotion-state information by processing input data from the terminal device using an emotion recognition model to generate an emotion label and a preference tendency score, and construct a prompt sentence encoding the structured attribute vector, the ranked candidate item records, the configuration data, the first and second component candidates, the user history information, and the emotion label; and
transmit the prompt sentence to a generative neural network model to obtain a configuration plan, adjust a presentation content of the configuration plan based on the emotion label and the preference tendency score, and transmit the adjusted configuration plan to the terminal device via the communication interface.

19. The system according to claim 18, wherein the circuitry is configured to update the user history information based on a final selection result received from the terminal device, recompute priority scores for subsequent search operations based on the updated user history information, and generate a training pair comprising the prompt sentence and the final selection result for fine-tuning the generative neural network model.

20. A method comprising:
receiving, via a communication interface coupled to a packet-switched network, query specification data from a terminal device, and applying a natural language processing model to the query specification data to extract a structured attribute vector comprising feature parameters and constraint parameters;
searching a first database stored in a storage device using the structured attribute vector as a query key to extract a set of candidate item records, and retrieving configuration data associated with each candidate item record;
applying a compatibility matching algorithm to select, from a second database, a first set of component candidates satisfying compatibility conditions with the configuration data, and applying a constraint satisfaction algorithm to select, from a third database, a second set of component candidates satisfying compatibility conditions with the first set of component candidates and the configuration data;
retrieving user history information comprising an input history and a selection history from the storage device, applying a weighted scoring function to the user history information to compute priority scores for the candidate item records and the component candidates, and ranking the candidate item records and the component candidates according to the priority scores;
obtaining emotion-state information of the user by processing input data received from the terminal device using an emotion recognition model to generate an emotion label and a preference tendency score, and constructing a prompt sentence for a generative neural network model by encoding the structured attribute vector, the ranked candidate item records, the configuration data, the first set of component candidates, the second set of component candidates, the user history information, and the emotion label as input fields; and
transmitting the prompt sentence to the generative neural network model to obtain a configuration plan, adjusting a presentation content of the configuration plan based on the emotion label and the preference tendency score, and transmitting the adjusted configuration plan to the terminal device via the communication interface.
